(19) United States
(12) Patent Application Publication
(10) Pub. No.: US 2023/0295375 A1
(43) Pub. Date: Sep. 21, 2023

(54) (METH)ACRYLOYL-FUNCTIONALIZED AMIDE-CONTAINING OLIGOMERS

(71) Applicant: Arkema France, Colombes (FR)

(72) Inventors: Brendan McGrail, Exton, PA (US); Jeffrey Klang, Exton, PA (US); William Wolf, Exton, PA (US); Guillaume Monnier, Verneuil En Halatte (FR); Christophe Duquenne, Verneuil En Halatte (FR)

(21) Appl. No.: 18/011,245

(22) PCT Filed: Jun. 30, 2021
(86) PCT No.: PCT/EP2021/068104

§ 371 Date: Dec. 19, 2022

(30) Foreign Application Priority Data
Jun. 30, 2020 (FR) FR2006892

(51) Int. Cl. C08G 69/44; C08L 77/12; C08J 7/12; B33Y 70/00

(52) U.S. Cl. CPC C08G 69/44; C08L 77/12; C08J 7/123; B33Y 70/00; C08G 2115/00; C08G 2150/00; C08G 2170/00; C08G 2190/00; C08J 2377/12

(57) ABSTRACT

Oligomeric substances which contain one or more (meth)acryloyl functional groups as well as two or more amide functional groups are useful as components of compositions which may be cured using actinic irradiation to provide polymeric articles.

### FIELD OF THE INVENTION

The present invention pertains to oligomeric substances which contain one or more (meth)acryloyl functional groups as well as two or more amide functional groups. In one embodiment, the oligomeric substance has a block copolymer-based backbone made up of at least one polyamide block and at least one non-polyamide block. In other embodiments, the oligomeric substance contains at least two amide functional groups and at least two structural units corresponding to [C(═O)(CHR¹)ₐO], wherein a is an integer of 2 to 5 and R¹ is H or alkyl. The invention additionally relates to methods of making such oligomers, curable compositions containing such oligomers, methods of curing such curable compositions, cured compositions and articles containing the curable compositions in cured form as well as methods of making such cured compositions and articles.

### BACKGROUND OF THE INVENTION

Photocurable compositions capable of being cured through exposure to actinic radiation to yield useful products such as adhesives, coatings, inks, 3D-printed articles and the like have been of interest for some time. Although such photocurable compositions are generally based on relatively low molecular weight (meth)acryloyl-functionalized compounds, which are generally referred to as “monomers,” the use of oligomeric higher molecular weight substances containing one or more photoreactive (meth)acryloyl functional groups per molecule in combination with such monomers is also well known. The incorporation of such functionalized oligomers in curable compositions can lead to favorable improvements in certain properties of the cured materials prepared therefrom. Many different types of (meth)acryloyl-functionalized oligomers have been developed, with (meth)acryloyl-functionalized urethane oligomers (i.e., oligomers having a polyurethane-type backbone) being of particular interest.

Certain polyamide-based oligomers which are functionalized with (meth)acrylate groups are also known. For example, WO 03/028992 A1 describes radiation-curable compositions comprised of the reaction product of an amine-terminated (poly)aminoamide and a mono- or poly(meth)acrylate. Acrylate-modified aminoamide resins which are the Michael additional product of an aminoamide thermoplastic polymer derived from a polymerized unsaturated fatty acid with a polyol ester having at least three (meth)acrylate ester groups are disclosed in WO 2006/067639 A2. Radiation-curable aminoamide acrylate polymers are also taught in EP 0381354 A2. U.S. Pat. No. 9,187,656 B2 discloses modified polyamide acrylate oligomers. Photosensitive aromatic polyamides containing photosensitive groups such as (meth)acryloyl groups are described in JP 2676662.

A radiation-curable resin coating composition containing, in a specific ratio, a soluble polyamide resin (not containing any (meth)acryloyl functional groups) and a radiation-polymerizable monomer or the like dissolved in a solvent is disclosed in U.S. Pat. No. 4,384,011. EP 0919873 teaches photocurable resin compositions comprised of (A) acid-modified vinyl group-containing epoxy resin, (B) an elastomer (such as a polyamide-based elastomer which does not contain any (meth)acryloyl functional groups), (C) a photopolymerization initiator, (D) a diluent and (E) a curing agent.

WO 2018/033296 A1 discloses polymerization-induced phase-separating compositions for acrylate-based networks which may include, as components, an acrylic based monomer, a copolymer of block A and block B, and a multifunctional cross-linker. There is no teaching that the copolymer could contain a polyamide block or (meth)acryloyl functional groups.

Despite the work done to date in this field, the need remains for photocurable oligomers which are capable of imparting different and/or improved properties to the cured products prepared from compositions containing such oligomers, possibly in combination with one or more other components such as (meth)acryloyl-functionalized monomers.

### SUMMARY OF THE INVENTION

A (meth)acryloyl-functionalized amide-containing oligomer is provided. The (meth)acryloyl-functionalized amide-containing oligomer either:
i.) comprises at least one polyamide block and at least one non-polyamide block and is substituted with at least one (meth)acryloyl functional group; or
ii.) has structure (IIa) or structure (IIb) or structure (IIc) or structure (IId) or structure (IIe) or structure (Ilf) or structure (IIg):

A¹—[O—(CHR¹)ₙ—(═O)]_{w}—N(R²)—R³—N(R²—[C(═O)—(CHR¹)₁—O]ₓ—A² (IIa);

A¹—[NH—(CHR¹)_{b}—C(═O)]_{w}—NH—R³—NH—[C(═O)—(CHR¹)_{b}—NH]ₓ—A² (IIb);

A¹—C(═O)—R⁴—C(═O)—[N(R⁵)—R⁶—N(R⁵)—C(═O)—R⁴—C(═O)]_{c}—A² (IIc);

A¹—N(R⁵)—R⁶—N(R⁵)—[C(═O)—R⁴—C(═O)—N(R⁵)—R⁶—N(R⁴)]_{d}—A² (IId);

A¹—[O—(CHR¹)ₐ—C(═)]_{w}—N(R²)—R³—N(R²)—[C(═O)—(CHR¹)ₐ—O]ₓ—C(═O)—R⁴—(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O]_{z}—A² (IIe);

A¹—[NH—(CHR¹)_{b}—C(═O)]_{w}—NH—R³—NH—[C(═O)—(CHR¹)_{b}—NH]ₓ—C(═O)—R⁴—C(═O)—[N(R⁵)—R⁶—N(R⁵)—C(═O)—R⁴—C(═O)]_{c}—[NH—(CHR¹)_{b}—C(═O)]_{y}—NH—R³—NH—[C(═O)—(CHR¹)_{b}—NH]_{z}—A² (IIf);

A¹—C(═O)—NH—R¹³—[NH—C(═O)—R⁴—C(═O)—NH—R¹³]ₑ—NH—C(═O)—A² (IIg);

wherein A¹ and A² are the same or different and are (meth)acryloyl-containing moieties:
a is an integer of 2 to 5;
b is an integer of 2 to 12, in particular 2 to 5;
c, d, e, w, x, y and z are the same or different and are each an integer of 1 or more;
R¹, R² and R⁵ are the same or different and are each H or an alkyl group and;
R³, R⁴, R⁶ and R¹³ are the same or different and are each a divalent organic moiety.

Also provided is a method of making the (meth)acryloyl-functionalized amide-containing oligomer that comprises at least one polyamide block and at least one non-polyamide block, as described above. The method may be one of three possibilities, (A), (B), or (C):
(A): Reacting together:
a) an amine- or hydroxyl-functionalized block copolymer comprising at least one polyamide block and at least one non-polyamide block and
b) a (meth)acryloyl-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; (meth)acrylic alkyl esters; poly(meth)acrylate-functionalized compounds; and cyclocarbonate-functionalized (meth)acrylates; or
(B): Reacting together:
a) an isocyano-functionalized block copolymer comprising at least one polyamide block and at least one non-polyamide block and
b) a hydroxyl-functionalized (meth)acrylate or a hydroxyl-functionalized (meth)acrylamide; or
(C): End-capping an anionically polymerized lactam with at least one epoxide comprising at least one epoxy-functional (meth)acrylic monomer.

Another object of the present invention is a curable composition comprised of at least one (meth)acryloyl-functionalized amide-containing oligomer in accordance with the invention and at least one additional component, in particular at least one (meth)acryloyl-functionalized compound and, optionally, a photoinitiator.

Another object of the present invention is a method of making a cured polymeric material, wherein the method comprises curing the curable composition of the invention using actinic radiation.

Yet another object of the present invention is a method of making a three-dimensional article by additive manufacturing, comprising using the curable composition of the invention to manufacture the three-dimensional article.

### DETAILED DESCRIPTION OF PARTICULAR EMBODIMENTS OF THE INVENTION

The term “molecular weight” as used throughout this specification unless otherwise indicated means a discrete molecular weight for a monomer and, for an oligomer or polymer, a number average molecular weight unless expressly noted otherwise, determined by gel permeation chromatography, using polystyrene standards and THF as the mobile phase, for comparison and is measured within five minutes after completion of the synthesis of the oligomer.

One aspect of the present invention relates to a (meth)acryloyl-functionalized amide-containing oligomer comprising at least one polyamide block and at least one non-polyamide block and substituted with at least one (meth)acryloyl functional group (sometimes referred to herein as a “Type A (meth)acryloyl-functionalized amide-containing oligomer”). As used herein, the term “(meth)acryloyl” includes both (meth)acrylate and (meth)acrylamide. As used herein, the term “(meth)acrylate” includes both acrylate and methacrylate. As used herein, the term “(meth)acrylamide” includes both acrylamide and methacrylamide. An acrylate functional group has the structure —OC(═O)CH═CH₂, while a methacrylate group has the structure —OC(═O)C(CH₃)═CH₂. An acrylamide functional group has the structure —NH—C(═O)CH═CH₂, while a methacrylamide group has the structure —NH—C(═O)C(CH₃)═CH₂. In particular, the at least one (meth)acryloyl functional group may be a (meth)acrylate functional group.

The term “polyamide block” refers to a segment containing a plurality of repeating units which are linked to each other through amide linkages. The term “non-polyamide block” refers to a segment containing a plurality of repeating units which are linked to each other through linkages other than amide linkages (such as ether, ester, or carbon-carbon linkages, as will be explained in more detail subsequently).

Another aspect of the present invention pertains to a (meth)acryloyl-functionalized amide-containing oligomer having structure (IIa) or structure (IIb) or structure (IIc) or structure (IId) or structure (IIe) or structure (IIf) or structure (IIg):

A¹—[O—(CHR¹)ₐ—C(═O)]_{w}—N(R²—R³—N(R²)—[C(═O)—(CHR¹)ₐ—O]ₓ—A² (IIa);

A¹—[NH—(CHR¹)_{b}—C(═O)]_{w}—NH—R³—NH—[C(═O)—(CHR¹)_{b}—NH]ₓ—A² (IIb);

A¹—C(═O)—R⁴—C(═O)—[N(R⁵)—R⁶—N(R⁴)—C(═O)—R⁴—C(═O)]_{c}—A² (IIc);

A¹—N(R⁵)—R⁶—N(R⁵)—[C(═O)—R⁴—C(═O)—N(R⁵)—R⁶—N(R⁵)]_{d}—A² (IId);

A¹—[O—(CHR¹)ₐ—C(═O)]_{w}—N(R²)—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O]_{z}—A² (IIe);

A¹—[NH—(CHR¹)_{b}—C(═O)]_{w}—NH—R³—NH—[C(═O)—(CHR¹)_{b}—NH]ₓ—C(═O)—R⁴—C(═O)—[N(R⁵)—R⁶—N(R⁵)—C(═O)—R⁴—C(═O)]ₓ—[NH—(CHR¹)_{b}—C(═O)]_{y}—NH—R³—NH—[C(═O)—(CHR¹)_{b}—NH]_{z}—A² (IIf);

A¹—C(═O)—NH—R¹³—[NH—C(═O)—R⁴—C(═O)—NH—R¹³]ₑ—NH—C(═O)—A² (IIg)

wherein A¹ and A² are the same or different and are (meth)acryloyl-containing moieties:
a is an integer of 2 to 5;
b is an integer of 2 to 12, in particular 2 to 5;
c, d, e, w, x, y and z are the same or different and are each an integer of 1 or more;
R¹, R² and R⁵ are the same or different and are each H or an alkyl group and;
R³, R⁴, R⁶ and R¹³ are the same or different and are each a divalent organic moiety.

Another aspect of the present invention pertains to a (meth)acryloyl-functionalized amide-containing oligomer having structure (IIa) or structure (IIe) or structure (IIf):

A¹—[O(CHR¹)_{z}C(═O)]_{w}—N(R²)—R³—N(R²)—[C(═O)(CHR¹)ₐO]ₓ—A² (IIa);

A¹—[O—(CHR¹)ₐ—C(═O)]_{w}—N(R²)—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O]_{z}—A² (IIe);

A¹—[NH—(CHR¹)_{b}—C(═O)]_{w}—NH—R³—NH—[C(═O)—(CHR¹)_{b}—NH]ₓ—C(═O)—R⁴—C(═O)—[N(R⁵)—R⁶—N(R⁵)—C(═O)—R⁴—C(═O)]ₓ—[NH—(CHR¹)_{b}—C(═O)]_{y}—NH—R³—NH—[C(═O)—(CHR¹)_{b}—NH]_{z}—A² (IIf);

wherein A¹ and A² are the same or different and are (meth)acryloyl-containing moieties, a is an integer of 2 to 5, w, x, y and z are the same or different and are each an integer of 1 or more, R¹, R² and R⁵ are the same or different and are each H or an alkyl group, and R³, R4 and R⁶ are the same or different and are each a divalent organic moiety.

An oligomer having structures such as structures (IIa or IIb or IIc or IId or IIe or IIf or IIg) is sometimes referred to herein as a “Type B (meth)acryloyl-functionalized amide-containing oligomer.”

One or more of the aforementioned (meth)acryloyl-functionalized amide-containing oligomers may be formulated together with at least one additional component, such as one or more (meth)acryloyl-functionalized compound other than the oligomer(s) and/or a photoinitiator, to provide a curable composition. Such curable composition may be cured using actinic radiation (e.g., ultraviolet light) and are useful as adhesives, sealants, coatings, three dimensional printing and additive manufacturing resins, inks and molding resins. Articles comprised of cured polymeric materials obtained by polymerization of the curable compositions represent another aspect of the invention. For example, a three-dimensional article may be made by an additive manufacturing process using curable compositions in accordance with the invention.

Type A (meth)acryloyl-functionalized amide-containing oligomers in accordance with the present invention may be made by a variety of synthetic routes, including, for example:
(A) reacting a) an amine- or hydroxyl-functionalized block copolymer comprising at least one polyamide block and at least one non-polyamide block and b) a (meth)acryloyl-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; (meth)acrylic alkyl esters; poly(meth)acrylate-functionalized compounds (particularly compounds comprised of at least one acrylate group and at least one methacrylate group) ; and cyclocarbonate-functionalized (meth)acrylates;
(B) reacting a) an isocyano-functionalized block copolymer comprising at least one polyamide block and at least one non-polyamide block and b) a hydroxyl-functionalized (meth)acrylate or a hydroxyl-functionalized (meth)acrylamide; or
(C) end-capping an anionically polymerized lactam with at least one epoxide comprising at least one epoxy-functional (meth)acrylic monomer.

By introducing one or more (meth)acryloyl functional groups onto a block copolymer containing at least one polyamide block, the resulting oligomer becomes covalently bonded into the polymeric matrix formed when compositions based on conventional (meth)acrylic monomers and oligomers are cured (in contrast to non-functionalized polyamide block-containing copolymers). However, the block copolymer character of the oligomer is capable of imparting significant enhancements to the physical and mechanical properties of the cured system.

### Type A (Meth)acryloyl-Functionalized Amide-Containing oligomers

A (meth)acryloyl-functionalized amide-containing oligomer in accordance with one aspect of the invention is comprised of at least one polyamide block and at least one non-polyamide block and is substituted with at least one (meth)acryloyl functional group (i.e., the oligomer contains at least one acrylate, methacrylate, acrylamide or methacrylamide functional group). In particular, the (meth)acryloyl-functionalized amide-containing oligomer may be substituted with at least one (meth)acrylate functional group. For example, each (meth)acryloyl group (in particular each (meth)acrylate group) may be substituted at a terminal position of a block copolymer segment comprised of at least one polyamide block and at least one non-polyamide block. However, it is also possible for the (meth)acryloyl groups functional group(s) (in particular the (meth)acrylate functional group(s)) to be substituted along the backbone or at the chain ends of the block copolymer. The (meth)acryloyl-functionalized amide-containing oligomer may be substituted with two or more (meth)acryloyl groups, in particular two or more (meth)acrylate groups. Such (meth)acryloyl groups may be substituted at each terminal position of the block copolymer, which may have a linear, branched or radial structure. In other embodiments, one or more of the non-polyamide blocks may be substituted with a plurality of (meth)acryloyl functional groups, in particular a plurality of (meth)acrylate functional groups. Successive polyamide blocks and non-polyamide blocks may be linked together directly or through non-polymeric linking moieties which form covalent bonds with both a polyamide block and a non-polyamide block. The linking moieties may be divalent in certain embodiments of the invention (i.e., —R—, where R is a linking moiety, which typically is an organic moiety). However, in other embodiments the linking moieties may be trivalent, tetravalent, etc. and provide sites of branching in the oligomer.

The Type A (meth)acryloyl-functionalized amide-containing oligomer may, for example, have a structure —(A—B)ₘ— or —(A—B)ₙ—A— wherein each of m and n is an integer of at least 1 (e.g., 1-6), A is a polyamide block, and B is a non-polyamide block. According to certain embodiments of the invention, the block copolymer segment may have structure —A—B—A— wherein A is a polyamide block and B is a non-polyamide block.

The polyamide and non-polyamide blocks in the Type A (meth)acryloyl-functionalized amide-containing oligomer may be selected to have disparate properties, for example, different glass transition temperatures. For instance, the at least one polyamide block may have a glass transition temperature of 30° C. or more and the at least one non-polyamide block may have a glass transition temperature of 0° C. or less.

The number average molecular weight of the Type A (meth)acryloyl-functionalized amide-containing oligomer may be varied as may be desired in order to provide certain properties and characteristics, both in the oligomer itself and cured products obtained by curing compositions containing such oligomers. For example, the Type A (meth)acryloyl-functionalized amide-containing oligomer may have a number average molecular weight of 2,000 g/mol to 100,000 g/mol. The molecular weight distribution (Mw/Mn, sometimes referred to as “polydispersity”) of the oligomer could range from 1 to 3, according to exemplary aspects of the invention.

Depending upon the chemical composition of the Type A (meth)acryloyl-functionalized amide-containing oligomer (e.g., the structures of the polyamide block(s) and non-polyamide block(s)) and its molecular weight, the physical form of the oligomer can vary significantly. For example, the oligomer could be a liquid or a solid at room temperature (25° C.). According to certain embodiments, the Type A oligomer is a thermoplastic or thermoplastic elastomer. The Type A (meth)acryloyl-functionalized amide-containing oligomer may be amorphous (non-crystalline), but in other embodiments may have some degree of crystallinity.

The polyamide block(s) may represent from 10 to 90% or from 20 to 80% by weight of the total weight of blocks present in the Type A oligomer, with the non-polyamide block(s) representing from 90 to 10% or from 80 to 20% by weight of the total weight of the blocks present in the oligomer. In one embodiment, the polyamide block(s) may represent from 30 to 70% or from 40 to 60% by weight of the total weight of blocks present in the Type A oligomer, with the non-polyamide block(s) representing from 70 to 30% or from 60 to 40% by weight of the total weight of the blocks present in the oligomer. In another embodiment, the polyamide block(s) may represent from 50 to 90% or from 60 to 80% by weight of the total weight of blocks present in the Type A oligomer, with the non-polyamide block(s) representing from 10 to 50% or from 20 to 40% by weight of the total weight of the blocks present in the oligomer. In yet another embodiment, the polyamide block(s) may represent from 10 to 50% or from 20 to 40% by weight of the total weight of blocks present in the Type A oligomer, with the non-polyamide block(s) representing from 50 to 90% or from 60 to 80% by weight of the total weight of the blocks present in the oligomer.

### Polyamide Block(s)

The Type A (meth)acryloyl-functionalized amide-containing oligomers of the present invention are characterized by containing at least one polyamide block. In certain embodiments, the (meth)acryloyl-functionalized amide-containing oligomer may be comprised of two or more polyamide blocks. In such embodiments, the polyamide blocks may be separated from each other by non-polyamide blocks (e.g., a non-polyamide block may be positioned between two polyamide blocks or vice versa). When the oligomer contains a plurality of polyamide blocks, such blocks may be the same as or different from each other. For example, the polyamide blocks may have the same number average molecular weight and/or the same chemical composition.

In the context of the present invention, a polyamide block may be defined as a segment containing a plurality of repeating units linked by amide linkages. The number of repeating units in each polyamide block is not particularly limited and may range, for example, from about 4 to about 800 or from 5 to 750. According to certain embodiments, each polyamide block may have a number average molecular weight of 400 g/mol to 75, 000 g/mol, or 500 g/mol to 75,000 g/mol. In particular, each polyamide block may have a number average molecular weight of 400 g/mol to 20,000 g/mol, or 500 g/mol to 10,000 g/mol. The molecular weight distribution (polydispersity, Mw/Mn) of each polyamide block can vary, for example, from 1 to about 3.

The polyamide block(s) may be (a) block(s) of homo-polyamides or co-polyamides. Aliphatic polyamide blocks are employed in certain embodiments of the invention, but aromatic polyamide blocks could also be used. According to certain embodiments of the invention, the (meth)acryloyl-functionalized amide-containing oligomer may comprise at least one polyamide block selected from the group consisting of polyamide 6,6 blocks; polyamide 6,10 blocks; polyamide 10,10 blocks; polyamide 6,12 blocks; polyamide 4,6 blocks; polyamide 6 blocks; polyamide 11 blocks; and polyamide 12 blocks.

The polyamide block(s) may have a structure according to Formula (III):

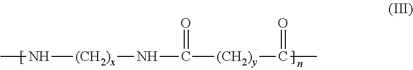

wherein X may be an integer of from 2 to 12, Y may be an integer of from 2 to 12, and n may be an integer of from 5 to 750. For example, both X and Y may be 4 (to provide a polyamide 4,6 block); X may be 6 and Y may be 4 (to provide a polyamide 6,6 block); X may be 6 and Y may be 8 (to provide a polyamide 6,10 block); or X may be 6 and Y may be 10 (to provide a polyamide 6,12 block).

The polyamide block(s) could also have a structure according to Formula (IV):

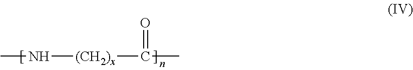

wherein X could be an integer of 2 to 12 and n could be an integer of 5 to 750. For example, X may be 5 (to provide a polyamide 6 block); X may be 10 (to provide a polyamide 11 block); or X may be 11 (to provide a polyamide 12 block).

In certain embodiments of the invention, the polyamide block(s) may be selected to provide a so-called “hard” segment or segments within the Type A (meth)acryloyl-functionalized amide-containing oligomer, that is, a polymeric block or polymeric blocks having a glass transition temperature (Tg) which is higher than the glass transition temperature of the non-polyamide block(s). For instance, the Tg of the polyamide block(s) may be at least 20° C., at least 30° C., at least 40° C. or at least 50° C. higher than the Tg of the non-polyamide block(s). In exemplary embodiments, the polyamide block(s) may have a Tg of at least 30° C., at least 40° C., at least 50° C. or at least 60° C.

### Non-Polyamide Blocks

As previously mentioned, the Type A (meth)acryloyl-functionalized amide-containing oligomers of the present invention are characterized by the presence of at least one non-polyamide block, in addition to at least one polyamide block. Each non-polyamide block may be a segment containing a plurality of repeating units which are linked to each other through linkages other than amide linkages such as ether, ester, or carbon-carbon linkages.

In certain embodiments, the (meth)acryloyl-functionalized amide-containing oligomer may be comprised of two or more non-polyamide blocks. In such embodiments, the non-polyamide blocks may be separated from each other by polyamide blocks (e.g., a polyamide block may be positioned between two non-polyamide blocks or vice versa). When the oligomer contains a plurality of non-polyamide blocks, such blocks may be the same as or different from each other. For example, the non-polyamide blocks may have the same number average molecular weight and/or the same chemical composition.

In the context of the present invention, a non-polyamide block may be defined as a segment containing a plurality of repeating units linked by linkages other than amide linkages. The number of repeating units in each non-polyamide block is not particularly limited and may range, for example, from about 4 to about 800 or from 5 to 750. According to certain embodiments, each non-polyamide block may have a number average molecular weight of 100 g/mol to 75,000 g/mol or 1,000 g/mol to 75,000 g/mol. In particular, each non-polyamide block may have a number average molecular weight of 100 g/mol to 6,000 g/mol, or 200 g/mol to 3,000 g/mol. The molecular weight distribution (polydispersity, Mw/Mn) of each non-polyamide block can vary, for example, from 1 to about 3.

In certain embodiments of the invention, the non-polyamide block(s) may be selected to provide a so-called “soft” segment or segments within the (meth)acryloyl-functionalized amide-containing oligomer, that is, a polymeric block or polymeric blocks having a glass transition temperature (Tg) which is lower than the glass transition temperature of the polyamide block(s). For instance, the Tg of the non-polyamide block(s) may be at least 20° C., at least 30° C., at least 40° C. or at least 50° C. lower than the Tg of the polyamide block(s). In exemplary embodiments, the non-polyamide block(s) may have a Tg less than 0° C., less than −10° C., less than −20° C. or less than −30° C.

According to certain aspects of the invention, the at least one non-polyamide block may be selected from the group consisting of polyether blocks, polyester blocks, polyether-ester blocks, polycarbonate blocks, polydiene blocks and polyorganosiloxane blocks, preferably polyether blocks and polyorganosiloxane blocks. For instance, the at least one non-polyamide block may be selected from the group consisting of polyethylene glycol blocks, polypropylene glycol blocks, polytetramethylene glycol blocks, polydimethylsiloxane blocks, and ethoxylated bis-phenol A blocks.

In particular, the at least one non-polyamide block may comprise a block selected from the group consisting of polyethylene glycol blocks, polypropylene glycol blocks, polytrimethylene glycol blocks, polytetramethylene glycol blocks, polydimethylsiloxane blocks and combinations thereof.

Suitable polyether blocks include in particular aliphatic polyether blocks, although aromatic or aromatic/aliphatic polyether blocks could also be employed. Preferably, the polyether block is aliphatic. The polyether blocks may, for example, be derived from ring-opening polymerization of cyclic ethers such as substituted and unsubstituted tetrahydrofurans, oxetanes and epoxides (such as ethylene oxide and propylene oxide). The polyether blocks may be linear or branched.

Polyether blocks may, in certain embodiments, have a structure according to Formula (Va):

—[(CR^{a}R^{b})ₘO]ₙ— (Va)

wherein m is an integer of 2 to 4,
n is an integer of 4 to 800, in particular 10 to 800; and
each R^{a} and R^{b} is independently H or alkyl, in particular H or methyl.

Polyether blocks may, in certain embodiments, have a structure according to Formula (Vb):

—[(CH₂)ₘO]ₙ— (Vb)

wherein m is an integer of 2 to 4 and n is an integer of 10 to 800, with at least one hydrogen substituted on a carbon atom of the sequence (CH₂)ₘ optionally being replaced with a substituent such as an alkyl group (e.g., methyl). For example, the repeating unit [(CH₂)ₘO] could be [CH₂CH₂O]; [CH₂CH₂CH₂O]; [CH₂CH(CH₃)O]; or [CH₂CH₂CH₂CH₂O].

Suitable polyester blocks can be made by polycondensation reactions of polyhydroxyl functional components (in particular, diols) and polycarboxylic acid functional compounds (in particular, dicarboxylic acids and anhydrides). Suitable diols include, for example, ethylene glycol, 1,4-butanediol and the like. Suitable dicarboxylic acids include, for example, adipic acid, succinic acid, oxalic acid, malonic acid, pimelic acid, suberic acid, sebacic acid, dodecanedioic acid, eicosanedioic acid and the like. Aromatic diacids such as phthalic acid could also be utilized. The polyhydroxyl functional and polycarboxylic acid functional components can each have linear, branched, cycloaliphatic or aromatic structures and can be used individually or as mixtures. Polyester blocks can also be prepared by ring-opening polymerization of lactones, such as caprolactone and valerolactone, and dilactones such as glycolides and lactides, as well as by polycondensation reactions of hydroxycarboxylic acids.

The polyester blocks in certain embodiments may have a structure according to Formula (VI):

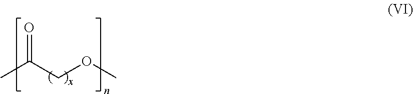

wherein x is an integer of from 1 to 12 and n is an integer of from 10 to 800. One or more of the methylene (CH₂) moieties may be substituted, such as with one or two alkyl groups such as methyl groups.

The polyester blocks in certain other embodiments may have a structure according to Formula (VII):

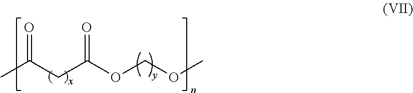

wherein x is an integer of from 2 to 12, y is an integer of from 2 to 12, and n is an integer of from 10 to 800. One or more of the methylene (CH₂) moieties may be substituted, such as with one or two alkyl groups such as methyl groups.

Polyether-ester blocks represent another type of non-polyamide block that could be present in the Type A (meth)acryloyl-functionalized amide-containing oligomers of the present invention. Polyether-ester blocks are characterized as blocks containing repeating units linked by ester linkages which additionally contain a plurality of ether moieties within each repeating unit. Typically, such polyether-ester blocks may be formed by polycondensation of a poly(oxyalkylene glycol), such as a polyethylene glycol, polypropylene glycol or polytetrametheylene glycol and a dicarboxylic acid or synthetic equivalent thereof such as adipic acid or succinic acid. In one embodiment, the polyether-ester block is aliphatic. For example, a suitable polyether-ester block may have a structure corresponding to Formula (VIII):

—[C(═O)(CH₂)ₚC(═O)—O—((CH₂)_{q}O)ᵣ]ₙ— (VIII)

wherein p is an integer of 2 to 12, q is an integer of 2 to 4, r is an integer of 2 to 20, and n is an integer of 4 to 800. One or more of the methylene (CH2) moieties in the repeating unit may be substituted, such as with one or two alkyl groups such as methyl groups.

In still other embodiments of the invention, the non-polyamide block may be a polydiene block. Such polydiene blocks may be obtained by polymerization of dienes such as butadiene and isoprene.

The non-polyamide block(s) could also be polycarbonate blocks, especially aliphatic polycarbonate blocks.

Polyorganosiloxane blocks may also be utilized as the non-polyamide blocks in the Type A oligomers of the present invention. Such blocks may correspond to the structure of Formula (IX):

—[SiR¹R²—O]ₙ— (IX)

wherein R¹ and R² may be the same or different and may be an organic moiety such as an alkyl or aryl group (e.g., methyl, ethyl, phenyl, benzyl) and n is an integer of from 4 to 800.

### Methods of Making Type A (Meth)Acryloyl-Functionalized Amide-Containing Oligomers

Although the Type A (meth)acryloyl-functionalized amide-containing oligomers of the present invention may be prepared by any suitable method, one suitable synthetic approach is to convert one or more non-(meth)acryloyl functional groups present in a block copolymer containing at least one polyamide block and at least one non-polyamide block to a (meth)acryloyl functional group, in particular a (meth)acrylate functional group. The starting block copolymer may be obtained using any procedure known in the art, such as a living polymerization to directly form the starting block copolymer or a condensation polymerization wherein at least one polyamide is linked together with at least one non-polyamide polymer either through reaction of complementary functional groups on each of the polyamide and non-polyamide polymer or by the use of linking reagents capable of forming linking moieties between the polyamide and the non-polyamide polymer. It is also possible to form the starting block copolymer by preparing a first block (a polyamide or a non-polyamide polymer) and then initiating polymerization of monomer off the first block to form at least one further block that is different from the first block (a non-polyamide block where the first block is a polyamide block, a polyamide block where the first block is a non-polyamide block).

The (meth)acryloyl functionalization of the block copolymer thereby obtained may be carried out using any suitable chemistry, which will depend upon the type of functional group present in the block copolymer that is capable of being transformed or converted into a (meth)acryloyl group, in particular a (meth)acrylate group. According to certain aspects of the invention, such functional group may, for example, be an active hydrogen-containing functional group, such as a hydroxyl, primary amine, secondary amine or carboxylic acid functional group. For example, the functional group(s) on the block copolymer may be capable of reacting with an isocyanate, acid halide, ester, carboxylic acid, anhydride or acrylate group which is present on a functionalization reagent also containing one or more (meth)acryloyl functional groups, in particular one or more (meth)acrylate functional groups. Non-limiting examples of such functionalization reactions include, but are not limited to the following: and Ware independently H or alkyl.

In the above structural formulae, R^{a} is a block copolymer moiety, R^{b} is an organic moiety to which the depicted reactive functional group and the (meth)acryloyl functional group are each attached, R^{c} is H or methyl, and R^{d} is an organic moiety such as an alkylene moiety (subject to the understanding that the depicted (meth)acryloyl functionalization may be taking place at a plurality of sites on the block copolymer (e.g., at each terminal end of the block copolymer, at multiple sites along the backbone of the block copolymer, or at both one or more terminal ends and/or one or more sites along the block copolymer backbone, in one or both of the polyamide block(s) and the non-polyamide block(s)), as well as the understanding that the functionalization reagent may contain two or more (meth)acryloyl groups per molecule).

Illustrative examples of how the present Type A (meth)acrylate-functionalized amide-containing oligomers may be synthesized include the following:
(A) reacting a) an amine- or hydroxyl-functionalized block copolymer comprising at least one polyamide block and at least one non-polyamide block and b) a (meth)acrylate-functionalizing reagent selected from the group consisting of isocyano-functionalized (meth)acrylates (e.g., the 1:1 adduct of a diisocyanate and a hydroxyl-functionalized (meth)acrylate such as hydroxyethyl(meth)acrylate); epoxy-functionalized (meth)acrylates (e.g., glycidyl (meth)acrylate, the 1:1 adduct of a diglycidyl ether and (meth)acrylic acid); (meth)acryloyl halides; (meth)acrylic acid; (meth)acrylic anhydride; (meth)acrylic alkyl esters; poly(meth)acrylate-functionalized compounds (in particular those containing at least one acrylate group and at least one methacrylate group); and cyclocarbonate functionalized (meth)acrylates (e.g. glycerol carbonate (meth)acrylate obtained by reacting glycidyl (meth)acrylate with CO₂);
(B) reacting a) an isocyano-functionalized block copolymer comprising at least one polyamide block and at least one non-polyamide block and b) a hydroxyl-functionalized (meth)acrylate or a hydroxyl-functionalized (meth)acrylamide (such as hydroxyethyl (meth)acrylate or hydroxypropyl (meth)acrylamide); and
(C) reacting an anionically polymerized lactam (having amino or lactam end groups) with at least one epoxide comprising at least one epoxy-functional (meth)acrylic monomer.

In certain embodiments of the invention, the block copolymer used to prepare the Type A (meth)acryloyl-functionalized amide-containing oligomer has one or more primary amine groups which are in the terminal position of a polyamide block (e.g., the block copolymer may be amine-terminated). A lactam (cyclic amide) such as caprolactam may be subjected to ring-opening polymerization to form a polyamide. These polyamides may have either amino or lactam end groups. Such primary amine groups or lactam end groups may be reacted with one or two equivalents of a polyol ester containing two or more (meth)acrylate groups. According to one embodiment, the polyol ester contains a single acrylate group, with the remaining (meth)acrylate groups being methacrylate groups. Such reaction may proceed by way of a Michael addition mechanism, for example:

R^{a}—NH₂+2H₂C═CHC(═O)O—R^{b}—O—C(═O)C(CH₃)═CH₂→R^{a}—N[CH₂CH₂C(═O)O—R^{b}—O—C(═O)C(CH₃)═CH₂]₂.

In the above structural formulae, R^{a} is a block copolymer moiety and R^{b} is an organic moiety which represents the polyol residue of the polyol ester (e.g., —CH₂CH(OH)CH₂—). Because the methacrylate group(s) are less reactive than the acrylate group, this synthetic approach will help to reduce issues with undesired gelation of the reaction product thereby obtained and favor the formation of the desired (meth)acrylate-functionalized amide-containing oligomer.

The polyol ester may contain two, three, four or more (meth)acrylate groups and may contain one or more unesterified hydroxyl groups. For example, the polyol ester may be a (meth)acrylate of a C₂-C₂₀ aliphatic (including cycloaliphatic) polyol (meaning an organic compound containing two or more hydroxyl groups per molecule. Polyols containing aromatic moieties could also be used, such as bis(hydroxypropyl) ethers of bisphenols such as bisphenol A. Examples of suitable polyol esters include, but are not limited to: di(meth)acrylates of ethylene glycol, propylene glycol, neopentyl glycol, 1,4-butanediol, and 1,6-hexanediol;

di(meth)acrylates of ethylene glycol oligomers such as diethylene glycol, triethylene glycol, and tetraethylene glycol; di(meth)acrylates of propylene glycol oligomers such as dipropylene glycol, tripropylene glycol and tetrapropylene glycol; glycerol di- and tri(meth)acrylates; sorbitol di- and tri(meth)acrylates; trimethylolethane di- and tri(meth)acrylates; trimethylolpropane di- and tri(meth)acrylates; dimethylolpropane di-, tri- and tetra(meth)acrylates; alkoxylated (e.g., ethoxylated, propoxylated) trimethylolpropane di- and tri(meth)acrylates;, alkoxylated (e.g., ethoxylated, propoxylated) glycerol di- and tri(meth)acrylates; pentaerythritol di-, tri- and tetra(meth)acrylates; dipentaerythritol di-, tri-, tetra-, penta- and hexa(meth)acrylates; alkoxylated pentaerythritol di-, tri- and tetra(meth)acrylates; and sucrose di-, tri- and tetra(meth)acrylates. In one embodiment of the invention, the polyol ester is glycerol in which one hydroxyl group is converted to an acrylate group and one hydroxyl group is converted to a methacrylate group.

The Michael addition reaction between the amine-functionalized block copolymer may be carried out at ambient temperature, but somewhat elevated temperatures may also be employed (for example, a temperature from 20° C. to 100° C. or from 20° C. to 75° C.). The stoichiometry between the polyol ester and the amine-functionalized block copolymer may be adjusted as may be desired, but generally the polyol ester is preferably employed in an amount at least equal to the stoichiometric amount needed to react with all of the free amine groups in the block copolymer. According to certain embodiments, the stoichiometry may be selected such that two moles of the polyol ester react with each mole of amine groups (so that two molecules of the polyol ester react with each amine group).

The (meth)acryloyl-functionalized amide-containing oligomers of the present invention could also be prepared by reacting an anionically polymerized lactam with at least one epoxide comprising at least one epoxy-functional (meth)acrylic monomer. That is, a lactam (cyclic amide) such as caprolactam may be subjected to ring-opening polymerization to form a polyamide. These polyamides may have either amino or lactam end groups. The polyamides thus formed may then be reacted with one or more epoxides, at least one of which is an epoxy-functional (meth)acrylic monomer (that is, a compound containing both an epoxy group and a (meth)acrylate group). Suitable epoxy-functional (meth)acrylic monomers include glycidyl (meth)acrylate, for example. The epoxy-functional (meth)acrylic monomer may be co-polymerized with one or more epoxides which do not contain (meth)acrylate functional groups, such as ethylene oxide and/or propylene oxide, to form a polyether block containing one or more pendant (meth)acrylate groups. The molar ratio of epoxy-functional (meth)acrylic monomer to non-epoxy-functional (meth)acrylic monomer can be varied as may be desired to control the (meth)acrylate functionality in the resulting (meth)acryloyl-functionalized amide-containing oligomer (i.e., the average number of (meth)acrylate functionality groups per molecule of the (meth)acryloyl-functionalized amide-containing oligomer). Optionally, an active hydrogen compound may be added to prevent undesired homopolymerization of the epoxide. Non-limiting examples of such compounds are primary alcohols, which may or may not contain one or more (meth)acrylate groups, such as ethanol, poly(ethylene glycol), or 2-hydroxylethyl (meth)acrylate may be used at 0 to 5 wt %, or 0.1 to 5 wt %, or 0.1 to 4 wt % or 0.1 to 3 wt %. Also suitable such active hydrogen compounds are secondary alcohols, which may or may not contain one or more (meth)acrylate groups, such as isopropanol, 2-hydroxy-3-phenoxy-1-propyl(meth)acrylate, bisphenol A di(meth)acrylate, and 2-hydroxypropyl (meth)acrylate. These may be incorporated at 0 to 10 wt % or 0.1 to 10 wt %, for example.

Yet another method of introducing (meth)acrylate functional groups onto a block copolymer containing one or more amino groups is to carry out oxidative carbonylation of the amino-substituted block copolymer by reacting the block copolymer with an alpha alkene (such as ethylene or propylene) and carbon monoxide in the presence of a suitable oxidative carbonylation catalyst (such as those described in U.S. Pat. No. 3,523,971, the teachings of which are incorporated herein by reference in their entirety for all purposes).

### Type B (Meth)Acryloyl-Functionalized Amide-Containing Oligomers

Type B (meth)acryloyl-functionalized amide-containing oligomers in accordance with certain aspects of the present invention are organic substances corresponding to structure (IIa) or structure (IIb) or structure (IIc) or structure (IId) or structure (IIe) or structure (IIf) or structure (IIg):

A¹—[O—(CHR¹)ₐ—C(═O)]_{w}—N(R²—R³—N(R²)—[C(═O)—(CHR¹)ₐ—O]ₓ—A² (IIa);

A¹—[NH—(CHR¹)_{b}—C(═O)]_{w}—NH—R³—NH—[C(═O)—(CHR¹)_{b}—NH]ₓ—A² (IIb);

A¹—C(═O)—R⁴—C(═O)—[N(R⁵)—R⁶—N(R⁴)—C(═O)—R⁴—C(═O)]_{c}—A² (IIc);

A¹—N(R⁵)—R⁶—N(R⁵)—[C(═O)—R⁴—C(═O)—N(R⁵)—R⁶—N(R⁵)]_{d}—A² (IId);

A¹—[O—(CHR¹)ₐ—C(═O)]_{w}—N(R²)—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O]_{z}—A² (IIe);

A¹—[NH—(CHR¹)_{b}—C(═O)]_{w}—NH—R³—NH—[C(═O)—(CHR¹)_{b}—NH]ₓ—C(═O)—R⁴—C(═O)—[N(R⁵)—R⁶—N(R⁵)—C(═O)—R⁴—C(═O)]ₓ—[NH—(CHR¹)_{b}—C(═O)]_{y}—NH—R³—NH—[C(═O)—(CHR¹)_{b}—NH]_{z}—A² (IIf);

A¹—C(═O)—NH—R¹³—[NH—C(═O)—R⁴—C(═O)—NH—R¹³]ₑ—NH—C(═O)—A² (IIg)

wherein A¹ and A² are the same or different and are (meth)acryloyl-containing moieties,
a is an integer of 2 to 5,
b is an integer of 2 to 12, in particular 2 to 5,
c, d, e, w, x, y and z are the same or different and are each an integer of 1 or more,
R¹, R² and R⁵ are the same or different and are each H or an alkyl group (wherein each R1 may be the same or different, each R² may be the same or different, and each R⁵ may be the same or different), and
R³, R⁴, R⁶ and R¹³ are the same or different and are each a divalent organic moiety.

The value of a in each [O—(CHR¹)ₐ—C(═O)] or the value of b in each [NH—(CHR¹)_{b}—C(═O)] structural unit within structure (IIa), structure (IIb), structure (IIe), structure (IIf) and structure (IIg) may be the same, but it is also possible for the value of a and b to vary between such structural units which are present in a single molecule of the Type B (meth)acryloyl-functionalized amide-containing oligomer. Furthermore, curable compositions of the present invention may comprise a component which is a mixture of compounds corresponding to structure (IIa) and/or structure (IIb) and/or structure (IIc) and/or structure to (IId) and/or structure (IIe) and/or structure (IIf) or structure (IIg) which differ from each other in one or more respects (such as the value of a, the values of w, x, y and z, and/or the identities (structures) of A¹, A², R¹, R², R³, R⁴, R⁵ and/or R⁶).

In one embodiment, R¹, R² and R⁵ are each H. However, in other embodiments, one or more of R¹, R² and R⁵ may be an alkyl group, in particular a C1-C6 alkyl group such as methyl, ethyl propyl and so forth.

According to further aspects, the sum of w and x in structure (IIa) or (IIB) may be an integer of from 2 to 10, i.e., w+x may be 2-10. In other aspects, the sum of w, x, y and z in structure (IIe) or (IIf) may be an integer of from 4 to 20, i.e., w+x+y+z may be 4-20.

In structure (IIc) or (IId) or (IIe) or (IIf), the value of c and d may be 1. Alternatively, the value of c and d may be higher than 1, for example c and d may independently be 2 to 10.

The nature of R³ and R⁶ is not limited and R³ and R⁶ may generally be any type of divalent organic moiety (e.g., an aliphatic or aromatic moiety, a moiety comprised of both aliphatic and aromatic components, or an aliphatic moiety containing one or more ether linkages). The divalent organic moiety may be a hydrocarbon, but could also comprise one or more heteroatoms such as halogen or oxygen atoms, so long as the moiety has a valence of two.

R³ and R⁶ may independently be selected from a straight chain or branched divalent alkylene; a chloralkyl moiety; a moiety containing one or more optionally substituted aromatic groups such as —Ar—, —Ar—Ar—, —Ar—CH₂—Ar—, —Ar—O—Ar—, —Ar—SO₂—Ar— or —CH₂—Ar—CH₂—; a moiety containing one or more optionally substituted cycloaliphatic groups such as -Cy-, —CH₂-Cy-, —CH₂-Cy—CH₂—, -Cy-CH₂-Cy- or -Cy-S-Cy-; or a divalent alkylene ether moiety such as -Alk¹-O(Alk²-O)ᵥAlk³-,

wherein each Ar is independently an optionally substituted aryl (e.g., phenyl); each Cy is independently an optionally substituted cycloalkyl (e.g., cyclohexyl);

Alk', Alk2 and Alk3 are the same or different and are each a divalent straight chain or branched alkylene moiety (in particular, —CH₂CH₂— and/or —CH(CH₃)CH₂—), and v is 0 or an integer of 1 or more (e.g., 1-50).

For example, R³ and/or R⁶ could be a straight chain chloralkyl moiety, such as —CH₂CHClCH₂—. R³ and/or R⁶ could include an aromatic group substituted with one or more Cl or F atoms, for example. In some embodiments, R³ and/or R⁶ may be -cyclohexyl-S-cyclohexyl- or —Ar—SO₂—Ar—.

For example, in certain embodiments R³ and/or R⁶ is —CH₂—Ar—CH₂— and Ar is an aromatic group (e.g., phenyl). In other embodiments, R³ and/or R⁶ is a divalent alkylene ether moiety such as -Alk¹-O(Alk²O)ᵥAlk³-, wherein v is 0 or an integer of 1 or more (e.g., 1-50) and Alk¹, Alk² and Alk³ are the same or different and are each a divalent straight chain or branched alkylene moiety (in particular, —CH₂CH₂— and/or —CH(CH₃)CH₂—). In yet another embodiment, R³ and/or R⁶ contains one or more cycloaliphatic moieties; e.g., R³ and/or R⁶ may be -Cyclohexyl-CH₂-Cyclohexyl- wherein Cyclohexyl is a divalent cyclohexyl moiety, which may be substituted or unsubstituted.

In particular, R³ may be —CH₂—Ar—CH₂—, wherein Ar is an aromatic group or -Cyclohexyl-CH₂-Cyclohexyl-, wherein Cyclohexyl is a divalent cyclohexyl moiety, which may be substituted or unsubstituted.

In particular, R⁶ may be a divalent alkylene ether moiety such as -Alk¹-O(Alk²O)ᵥAlk³-, wherein v is 0 or an integer of 1 or more (e.g., 1-50) and Alk¹, Alk² and Alk³ are the same or different and are each a divalent straight chain or branched alkylene moiety (in particular, —CH₂CH₂— and/or —CH(CH₃)CH₂—).

The nature of R⁴ is not limited and R⁴ may generally be any type of divalent organic moiety (e.g., an aliphatic or aromatic moiety, a moiety comprised of both aliphatic and aromatic components, or an aliphatic moiety containing one or more ether and/or ester linkages). The divalent organic moiety may be a hydrocarbon moiety which may optionally comprise heteroatoms such as oxygen. In particular, R⁴ may be selected from a straight chain or branched divalent alkylene; an optionally substituted aryl (e.g., phenyl); an optionally substituted cycloalkyl (e.g., cyclohexyl); a moiety comprising one or more ether and/or ester linkages; or a combination thereof.

A¹ and A² are moieties containing at least one (meth)acryloyl functional group. In one embodiment, A¹ and A² may consist of a (meth)acryloyl functional group. In another embodiment, A¹ and A² may be moieties containing at least one (meth)acrylate functional group. In yet another embodiment, A¹ and A² may be moieties containing at least one (meth)acrylamide functional group.

A¹ and A² may independently be selected from the group consisting of one of the following structures (XIII)-(XXII):

—C(═O)—CR^{c}═CH₂ (XIII);

—C(═O)—NH—R^{b}—O—C(═O)—CR^{c}═CH₂ (XIV);

—CH₂—CH(OH)—R^{b}—O—C(═O)—CR^{c}═CH₂ (XV);

—CH₂—CH₂—C(═O)—O—R^{b}—O—C(═O)—CR^{c}═CH₂ (XVI);

—C(═O)—NH—R^{b}—NH—C(═O)—O—R^{d}—Y—C(═O)—CR^{c}═CH₂ (XVII);

—C(═O)—R^{b}—C(═O)—O—CH₂—CH(OH)—CH₂—[O—R^{d}—O—CH₂—CH(OH)—CH₂]_{q}—O—C(═O)—CR^{c}═CH₂ (XVIII);

—O—R^{d}—Y—C(═O)—CR^{c}═CH₂ (XIX);

—O—CH₂—CH(OH)—R^{b}—O—C(═O)—CR^{c}—CH₂ (XX);

—NH—R^{b}—NH—[C(═O)—O—R^{d}—O]ᵣ—C(═O)—CR^{c}═CH₂ (XXI);

—C(═O)—O—R^{b}—O—C(═O)—CR^{c}═CH₂ (XXII);

wherein each R^{c} is independently H or methyl,
R^{b} and R^{d} are each independently a divalent organic moiety,

### Y is O or NH,

q is 0 to 10, in particular 0 or 1
r is 0 or 1.

When A¹ and/or A² are according to one of structures (XIII), (XIV), (XVI), (XVII) or (XVIII), they may be directly attached to an oxygen atom or a nitrogen atom of the (meth)acryloyl-functionalized amide-containing oligomer of the invention.

When A¹ and/or A² are according to one of structures (XV) or (XXII), they may be directly attached to a nitrogen atom of the (meth)acryloyl-functionalized amide-containing oligomer of the invention.

When A¹ and/or A² are according to one of structures (XIX), (XX) or (XXI), they may be directly attached to a carbon atom (in particular directly attached to the carbon atom of a carbonyl group) of the (meth)acryloyl-functionalized amide-containing oligomer of the invention.

In one embodiment, the (meth)acryloyl-functionalized amide-containing oligomer corresponds to structure (IIa) and A¹ and A² are independently selected from the group consisting of one of structures (XIII), (XIV), (XVI), (XVII) and (XVIII), preferably one of structures (XVII) and (XVIII), more preferably structure (XVII).

In one embodiment, the (meth)acryloyl-functionalized amide-containing oligomer corresponds to structure (IIb) or (IId) and A¹ and A² are independently selected from the group consisting of one of structures (XIII), (XIV), (XV), (XVI), (XVII), (XVIII) and (XXII), preferably one of structures (XIII), (XV), (XVI), (XVII) and (XXII), more preferably one of structures (XIII), (XV) and (XVI).

In one embodiment, the (meth)acryloyl-functionalized amide-containing oligomer corresponds to structure (IIc) and A¹ and A² are independently selected from the group consisting of one of structures (XIX), (XX) and (XXI), preferably one of structures (XX), (XXI), more preferably structure (XXI).

In one embodiment, the (meth)acryloyl-functionalized amide-containing oligomer corresponds to structure (IIe) and A¹ and A² are independently selected from the group consisting of one of structures (XIII), (XIV), (XVI), (XVII) and (XVIII), preferably one of structures (XIII) and (XIV), more preferably structure (XIII).

In one embodiment, the (meth)acryloyl-functionalized amide-containing oligomer corresponds to structure (IIf) and A¹ and A² are independently selected from the group consisting of one of structures (XIII), (XIV), (XV), (XVI), (XVII), (XVIII) and (XaII), preferably one of structures (XIII), (XV), (XVI) and (XXII), more preferably structure (XII).

In one embodiment, the (meth)acryloyl-functionalized amide-containing oligomer corresponds to structure (IIg) and A¹ and A² correspond to structure (XIX).

In particular embodiments, A¹ and A² are independently selected from the group to consisting of:

—C(═O)C(R⁷)═CH₂;
—C(═O)NH—R⁸—NHC(═O)OCH₂CH(R⁹)OC(═O)C(R¹⁰)═CH₂; and
—C(═O)CH₂CH₂C(═O)OCH₂CH(OH)CH₂O—R¹¹—O—CH₂CH(OH)CH₂OC(═O)C(R¹²)═CH₂,
wherein R⁷, R⁹, R¹⁹ and R¹² are independently H or methyl, and R⁸ and R¹¹ are each independently a divalent organic moiety.

### Structure (IIa)

A Type B (meth)acryloyl-functionalized amide-containing oligomer corresponding to structure (IIa) may be a reaction product of a lactone and a diamine which is functionalized with (meth)acryloyl groups, in particular with (meth)acrylate groups. For example, the Type B (meth)acryloyl-functionalized amide-containing oligomer of structure (IIa) may be obtained by ring-opening addition of a lactone to a diamine to obtain an amide-containing oligomer having hydroxyl end groups and reaction of the hydroxyl end groups to introduce (meth)acryloyl functional groups, in particular (meth)acrylate groups. For example, the hydroxyl end groups could be reacted with a (meth)acryloyl halide or a synthetic equivalent thereof (such as (meth)acrylic acid, (meth)acrylic anhydride or a (meth)acrylic acid ester).

A higher functionality polyamine, such as a triamine or a tetraamine, could be substituted for the diamine to prepare oligomers having structures analogous to structure (IIa) but which are branched and which contain three or more (meth)acryloyl functional groups, in particular three or more (meth)acrylate functional groups.

Suitable lactones include, for example, aliphatic lactones which are cyclic esters containing 4- to 7-membered rings, such as β-propiolactone, γ-butyrolactone, δ-valerolactone and ε-caprolactone and combinations thereof. One or more carbon atoms of the lactone ring could be substituted with an alkyl group. Examples of such alkyl-substituted lactones include β-butyrolactone, α-methyl-γ-butyrolactone, γ-valerolactone, γ-caprolactone, δ-octanolactone, γ-nonalactone, and γ-decanolactone. Mixtures of different lactones may be reacted with the diamine.

The amine groups of the diamine may be primary or secondary amine groups, with primary amine groups typically being preferred. Suitable diamines include aliphatic diamines, aromatic diamines and diamines containing both aliphatic and aromatic moieties. For instance, the diamine may be an aromatic compound in which an aromatic ring such as a phenyl ring is substituted with two —CH₂NH₂ groups (e.g., a xylylene diamine). The diamine could also contain one or more heteroatoms, such as oxygen atoms in particular. For example, the diamine could contain one or more ether linkages, such as in diamine compounds corresponding to the general formula H₂N—Alk¹-O(Alk²O)vAlk3-NH₂, wherein v is 0 or an integer of 1 or more (e.g., 1-50) and Alk¹, Alk² and Alk³ are the same or different and are each a divalent straight chain or branched alkylene moiety (in particular, —CH₂CH₂— and/or —CH(CH₃)CH₂—).

The stoichiometry between the lactone and the diamine can be varied as needed or desired to control the number of units of structure [C(═O)—(CHR¹)ₐ—O] per molecule which are present in the Type B (meth)acryloyl-functionalized amide-containing oligomer having structure (IIa). For example, from 2 to 10 or more moles of lactone per mole of diamine may be reacted.

The desired reaction between the lactone and the diamine may be uncatalyzed or may be promoted by the use of a suitable catalyst such as, for example, an acidic catalyst such as hypophosphorous acid. The reaction mixture may be heated at a temperature and for a time effective to achieve the desired addition of the lactone onto the amine groups of the diamine. Suitable reaction temperatures include, for example, 50° C. to 200° C. Suitable reaction times include, for example, 1 to 48 hours.

The reaction between the lactone and the diamine will typically yield an amide-containing oligomer having hydroxyl end groups. This intermediate product may correspond to structure (XXIII):

H—[O—(CHR¹)ₐ—C(═O)]_{w}—N(R²)—R³—N(R²)—[C(═O)—(CHR¹)ₐ—O]ₓ—H (XXIII)

wherein a, R¹, R², R³, w and x are as defined elsewhere herein.

The hydroxyl end groups may be reacted in various ways to introduce (meth)acryloyl functional groups, thereby providing the desired Type B (meth)acrylate-functionalized amide-containing oligomer corresponding to structure (IIa). For example, the intermediate product may be reacted with a (meth)acryloyl-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; (meth)acrylic alkyl esters. An alternative synthetic approach would be to react the intermediate product of structure (XXIII) with an excess of a polyisocyanate (e.g., a diisocyanate, in particular an aliphatic or aromatic diisocyanate such as isophorone diisocyanate or toluene diisocyanate) to obtain an isocyanate-terminated amide-containing oligomer and then react the isocyanate-functionalized amide-containing oligomer with a hydroxyalkyl (meth)acrylate such as hydroxyethyl (meth)acrylate or with a hydroxyalkyl (meth)acrylamide such as hydroxypropyl (meth)acrylamide. Yet another way to functionalize the intermediate product of structure (XXIII) with (meth)acryloyl groups would be to react the intermediate product with a cyclic anhydride (such as succinic anhydride) or a dicarboxylic acid to obtain a carboxylic acid-functionalized amide-containing oligomer, which is then reacted with a polyepoxy compound such as a diglycidyl ether and (meth)acrylic acid or with a glycidyl (meth)acrylate.

### Structure (IIb)

A Type B (meth)acryloyl-functionalized amide-containing oligomer corresponding to structure (IIb) may be a reaction product of a lactam and a diamine which is functionalized with (meth)acryloyl groups, in particular with (meth)acrylate groups or (meth)acrylamide groups. For example, the Type B (meth)acryloyl-functionalized amide-containing oligomer of structure (IIb) may be obtained by ring-opening addition of a lactam with a diamine to obtain an amide-containing oligomer having amine end groups and reaction of the amine end groups to introduce (meth)acryloyl functional groups, in particular (meth)acrylate groups or (meth)acrylamide groups. For example, the amine end groups could be reacted with a (meth)acryloyl halide or a synthetic equivalent thereof (such as (meth)acrylic acid, (meth)acrylic anhydride or a (meth)acrylic acid ester).

A higher functionality polyamine, such as a triamine or a tetraamine, could be substituted for the diamine to prepare oligomers having structures analogous to structure (IUD) but which are branched and which contain three or more (meth)acryloyl functional groups, in particular three or more (meth)acrylate functional groups or (meth)acrylamide functional groups.

Suitable lactams include, for example, aliphatic lactams which are cyclic amides containing 4- to 7-membered rings, such as β-propiolactam, γ-butyrolactam, δ-valerolactam and ε-caprolactam, oenantholactam and lauryllactam and combinations thereof. One or more carbon atoms of the lactam ring could be substituted with an alkyl group. Mixtures of different lactams may be reacted with the diamine.

The diamine may be as described above for structure (IIa).

The stoichiometry between the lactam and the diamine can be varied as needed or desired to control the number of units of structure [C(═O)—(CHR¹)_{b}—NH] per molecule which are present in the Type B (meth)acryloyl-functionalized amide-containing oligomer having structure (IIb). For example, from 2 to 10 or more moles of lactam per mole of diamine may be reacted.

The desired reaction between the lactam and the diamine may be carried out in the same conditions (presence or absence of catalyst, reaction temperature and length of reaction) as described above for structure (IIa).

The reaction between the lactam and the diamine will typically yield an amide-containing oligomer having amine end groups. This intermediate product may correspond to structure (XXIV):

H—[NH—(CHR¹)_{b}—C(═O)]_{w}—N(R²)—R³—N(R²)—[C(═O)—(CHR¹)_{b}—NH]ₓ—H (XXIV)

wherein b, R¹, R², R³, w and x are as defined elsewhere herein.

The amine end groups may be reacted in various ways to introduce (meth)acryloyl functional groups, thereby providing the desired Type B (meth)acrylate-functionalized amide-containing oligomer corresponding to structure (IUD). For example, the intermediate product may be reacted with a (meth)acryloyl-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; (meth)acrylic alkyl esters; poly(meth)acrylate-functionalized compounds (in particular those comprised of at least one acrylate group and at least one methacrylate group); and cyclocarbonate-functionalized (meth)acrylates. An alternative synthetic approach would be to react the intermediate product of structure (XXIV) with an excess of a polyisocyanate (e.g., a diisocyanate, in particular an aliphatic or aromatic diisocyanate such as isophorone diisocyanate or toluene diisocyanate) to obtain an isocyanate-terminated amide-containing oligomer and then react the isocyanate-functionalized amide-containing oligomer with a hydroxyalkyl (meth)acrylate such as hydroxyethyl (meth)acrylate or with a hydroxyalkyl (meth)acrylamide such as hydroxypropyl (meth)acrylamide. Yet another way to functionalize the intermediate product of structure (XXIV) with (meth)acryloyl groups would be to react the intermediate product with a cyclic anhydride (such as succinic anhydride) or a dicarboxylic acid to obtain a carboxylic acid-functionalized amide-containing oligomer, which is then reacted with a polyepoxy compound such as a diglycidyl ether and (meth)acrylic acid or with a glycidyl (meth)acrylate.

### Structures (IIc) and (IId)

A Type B (meth)acryloyl-functionalized amide-containing oligomer corresponding to structure (IIc) or (IId) may be a reaction product of a diamine with a cyclic anhydride or a dicarboxylic acid, which is functionalized with (meth)acryloyl groups, in particular with (meth)acrylate groups or (meth)acrylamide groups. For example, the Type B (meth)acryloyl-functionalized amide-containing oligomer of structure (IIc) may be obtained by reacting a diamine with a cyclic anhydride or a dicarboxylic acid to obtain an amide-containing oligomer having carboxylic acid end groups and reaction of the carboxylic acid end groups to introduce (meth)acryloyl functional groups, in particular (meth)acrylate groups or (meth)acrylamide groups. In another example, the Type B (meth)acryloyl-functionalized amide-containing oligomer of structure (IId) may be obtained by reacting a diamine with a cyclic anhydride or a dicarboxylic acid to obtain an amide-containing oligomer having amine end groups and reaction of the amine end groups to introduce (meth)acryloyl functional groups, in particular (meth)acrylate groups or (meth)acrylamide groups.

A higher functionality polyamine, such as a triamine or a tetraamine, could be substituted for the diamine to prepare oligomers having structures analogous to structure (IIc) or (IId) but which are branched and which contain three or more (meth)acryloyl functional groups, in particular three or more (meth)acrylate functional groups or (meth)acrylamide functional groups.

The reaction between the diamine and the cyclic anhydride or the dicarboxylic acid may yield an amide-containing oligomer having carboxylic acid end groups. This intermediate product (also referred to herein as an amic diacid) may correspond to structure (XXV):

H—C(═O)—R⁴—C(═O)—[N(R⁵)—R⁶—N(R⁵)—C(═O)—R⁴—C(═O)]_{c}—H (XXV)

wherein c, R⁴, R⁵ and R⁶ are as defined elsewhere herein.

The R⁴ portion of the anhydride or dicarboxylic acid may be saturated or unsaturated and may be a hydrocarbyl moiety (containing only carbon and hydrogen atoms) but may contain one or more heteroatoms (such as oxygen or halide atoms) in addition to carbon and hydrogen atoms. R⁴ may be aliphatic or aromatic or may contain both aliphatic and aromatic moieties. R⁴ may be linear or branched and may contain a ring structure such as a cyclohexyl group. Suitable cyclic anhydrides include, for example, succinic anhydride (R⁴=CH₂CH₂), 1,2-cyclohexanedicarboxylic anhydride, glutaric anhydride, methyl succinic anhydride, phenyl succinic anhydride and the like. Suitable dicarboxylic acids may be compounds corresponding to the aforementioned anhydrides in which the anhydride ring has been opened with water (for example, succinic acid rather than succinic anhydride may be utilized), as well as dicarboxylic acids corresponding generally to the structure HO—C(═O)—R⁴—C(═O)—OH. Examples of dicarboxylic acids that may be cited are 1,4-cyclohexyldicarboxylic acid, butanedioic, adipic, azelaic, suberic, sebacic, dodecanedicarboxylic, octadecanedicarboxylic acids and terephthalic and isophthalic acids, but also dimerized fatty acids.

The diamine may be as described above for oligomer of structure (IIa).

Typically, it will be desirable to control the stoichiometry of the reactants such that two moles of cyclic anhydride (or the like) are reacted with one mole of diamine. The reaction product thus obtained can thus have one carboxylic acid-functionalized residue derived from the cyclic anhydride or dicarboxylic acid reacted with each amine group of the diamine. The amic diacid thus can correspond to the following structure (XXVI):

HO—C(═O)—R⁴—C(═O)—N(R⁵)—R⁶—N(R⁵)C(═O)—R⁴—C(═O)—OH (XXVI)

wherein R⁴, R⁵, and R⁶ are as defined elsewhere herein.

The carboxylic acid end groups may be reacted in various ways to introduce (meth)acryloyl functional groups, thereby providing the desired Type B (meth)acrylate-functionalized amide-containing oligomer corresponding to structure (IIc). For example, the intermediate product may be reacted with a (meth)acryloyl-functionalizing reagent selected from the group consisting of isocyano-functionalized (meth)acrylates; epoxy-functionalized (meth)acrylates; hydroxy-functionalized (meth)acrylates; and hydroxy-functionalized (meth)acrylamides. An alternative synthetic approach would be to react the intermediate product of structure (XXV) with an excess of a polyisocyanate (e.g., a diisocyanate, in particular an aliphatic or aromatic diisocyanate such as isophorone diisocyanate or toluene diisocyanate) to obtain an isocyanate-terminated amide-containing oligomer and then react the isocyanate-functionalized amide-containing oligomer with a hydroxyalkyl (meth)acrylate such as hydroxyethyl (meth)acrylate or with a hydroxyalkyl (meth)acrylamide such as hydroxypropyl (meth)acrylamide. Yet another way to functionalize the intermediate product of structure (XXV) with (meth)acryloyl groups would be to react the intermediate product with a polyepoxy compound such as a diglycidyl ether and then with (meth)acrylic acid.

Alternatively, the reaction between the diamine and the cyclic anhydride or the dicarboxylic acid may yield an amide-containing oligomer having amine end groups. This intermediate product may correspond to structure (XXVII):

H—N(R⁵)—R⁶—N(R⁵)—[C(═O)—R⁴—C(═O)—N(R⁵)—R⁶—N(R⁵)]_{d}—H (XXVII)

wherein d, R⁴, R⁵ and R⁶ are as defined elsewhere herein.

The amine end groups may be reacted as described above for oligomers of structure (IIb) to introduce (meth)acryloyl functional groups, thereby providing the desired Type B (meth)acrylate-functionalized amide-containing oligomer corresponding to structure (IId).

A Type B (meth)acryloyl-functionalized amide-containing oligomer corresponding to structure (IId) may also be a reaction product of a diisocyanate with a dicarboxylic acid, which is functionalized with (meth)acryloyl groups. For example, the Type B (meth)acryloyl-functionalized amide-containing oligomer of structure (IId) may be obtained by reacting a diisocyanate with a dicarboxylic acid to obtain an amide-containing oligomer having isocyanate end groups and reaction of the isocyanate end groups with (meth)acrylic acid to introduce (meth)acrylamide groups, as described below for the oligomer of structure (IIg).

### Structure (IIe)

A Type B (meth)acryloyl-functionalized amide-containing oligomer corresponding to structure (IIe) may, for example, be a reaction product of an amic diacid and an oligo(ester-amide) diol which has been functionalized with (meth)acryloyl groups, in particular with (meth)acrylate groups. The amic diacid may be prepared, for example, by reacting a diamine with a cyclic anhydride or a dicarboxylic acid as described above for oligomers of structure (IIc). The oligo(ester-amide) diol may be prepared, for example, by ring-opening addition of a lactone to a diamine in a manner analogous to what has been previously described in connection with the synthesis of Type B oligomers in accordance with structure (IIa). The steps involved in this method of preparing an oligomer having structure (IIe) in accordance with certain aspects of the invention may be summarized as follows:
I. Diamine+cyclic anhydride (or dicarboxylic acid)→amic diacid;
II. Lactone+diamine→oligo(ester-amide) diol;
III. Amic diacid+oligo(ester-amide) diol→hydroxyl-functionalized intermediate;
IV. Hydroxyl-functionalized intermediate+(meth)acryloyl-functionalizing reagent→Structure (IIe) (meth)acryloyl-functionalized amide-containing oligomer

The diamines employed in Reactions I and II may be the same as or different from each other. The amine groups of the diamines may be primary or secondary amine groups, with primary amine groups typically being preferred. Suitable diamines include aliphatic diamines, aromatic diamines and diamines containing both aliphatic and aromatic moieties. For instance, the diamine may be an aromatic compound in which an aromatic ring such as a phenyl ring is substituted with two —CH₂NH₂ groups (e.g., a xylylene diamine). The diamine could also contain one or more heteroatoms, such as oxygen atoms in particular. For example, the diamine could contain one or more ether linkages, such as in diamine compounds corresponding to the general formula H₂N-Alk¹-O(Alk²O)ᵥAlk³-NH₂, wherein v is 0 or an integer of 1 or more (e.g., 1-50) and Alk¹, Alk² and Alk³ are the same or different and are each a divalent straight chain or branched alkylene moiety (in particular, —CH₂CH₂— and/or —CH(CH₃)CH₂—).

A higher functionality polyamine, such as a triamine or a tetraamine, could be substituted for the diamine of Reaction I and/or Reaction II to prepare oligomers having structures analogous to structure (He) but which are branched and which contain three or more (meth)acryloyl functional groups, in particular three or more (meth)acrylate groups.

With respect to Reaction I, the amic diacid may be prepared by reacting any of the above-mentioned diamines with a cyclic anhydride or a synthetic equivalent thereof such as a dicarboxylic acid as described above for oligomers of structure (IIc). Typically, it will be desirable to control the stoichiometry of the reactants such that two moles of cyclic anhydride (or the like) are reacted with one mole of diamine. The reaction product thus obtained can thus have one carboxylic acid-functionalized residue derived from the cyclic anhydride reacted with each amine group of the diamine. The amic diacid thus can correspond to the following structure (XXV) or (XXVI) as described above for oligomers of structure (IIc):

H—C(═O)—R⁴—C(═O)—[N(R⁵)—R⁶—N(R⁵)—C(═O)—R⁴—C(═O)]_{c}—H (XXV)

wherein c, R⁴, R⁵ and R⁶ are as defined elsewhere herein, or

HO—C(═O)—R⁴—C(═O)—N(R⁵)—R⁶—N(R⁵)C(═O)—R⁴—C(═O)—OH (XXVI)

wherein R⁴, R⁵, and R⁶ are as defined elsewhere herein.

The R⁴ portion of the anhydride or diacid may be saturated or unsaturated and may be a hydrocarbyl moiety (containing only carbon and hydrogen atoms) but may contain one or more heteroatoms (such as oxygen or halide atoms) in addition to carbon and hydrogen atoms. R⁴ may be aliphatic or aromatic or may contain both aliphatic and aromatic moieties. R⁴ may be linear or branched and may contain a ring structure such as a cyclohexyl group. Suitable cyclic anhydrides include, for example, succinic anhydride (R⁴═CH₂CH₂), 1,2-cyclohexanedicarboxylic anhydride, glutaric anhydride, methyl succinic anhydride, phenyl succinic anhydride and the like. Suitable dicarboxylic acids may be compounds corresponding to the aforementioned anhydrides in which the anhydride ring has been opened with water (for example, succinic acid rather than succinic anhydride may be utilized), as well as dicarboxylic acids corresponding generally to the structure HO—C(═O)—R⁴—C(═O)—OH.

With respect to Reaction II, suitable lactones are as described for oligomers of structure (Ha) and include, for example, aliphatic lactones which are cyclic esters containing 4- to 7-membered rings, such as β-propiolactone, γ-butyrolactone, δ-valerolactone and ε-caprolactone and combinations thereof. One or more carbon atoms of the lactone ring could be substituted with an alkyl group. Examples of such alkyl-substituted lactones include β-butyrolactone, α-methyl-γ-butyrolactone, γ-valerolactone, γ-caprolactone, δ-octanolactone, γ-nonalactone, and γ-decanolactone. Mixtures of different lactones may be reacted with the diamine.

The stoichiometry between the lactone and the diamine can be varied as needed or desired to control the number of units of structure [C(═O)(CHR¹)ₐO] per molecule which are present in the Type B (meth)acryloyl-functionalized amide-containing oligomer having structure (He). For example, from 2 to 10 or more moles of lactone per mole of diamine may be reacted.

The desired reaction between the lactone and the diamine may be uncatalyzed or may be promoted by the use of a suitable catalyst such as, for example, an acidic catalyst such as hypophosphorous acid. The reaction mixture may be heated at a temperature and for a time effective to achieve the desired addition of the lactone onto the amine groups of the diamine. Suitable reaction temperatures include, for example, 50° C. to 200° C. Suitable reaction times include, for example, 1 to 48 hours.

The reaction between the lactone and the diamine will typically yield an amide-containing oligomer having hydroxyl end groups (sometimes referred to herein as an “oligo(ester-amide) diol”). This intermediate product may correspond to structure (XXIII) as described above for oligomers of structure (IIa):

H—[O—(CHR¹)ₐ—C(═O)]_{w}—N(R²)—R³—N(R²)—[C(═O)—(CHR¹)ₐ—O]ₓ—H (XXIII)

wherein a, R¹, R², R³, w and x are as defined elsewhere herein.

With respect to Reaction III, the amic diacid and oligo(ester-amide) diol may be reacted at a stoichiometry and under conditions effective to react one molecule of the oligo(ester-amide) diol with each of the carboxylic acid groups on one molecule of the amic diacid (wherein the carboxylic acid groups are esterified by the oligo(ester-amide diol). For example, the reaction of the amic diacid and oligo(ester-amide) diol may proceed in accordance with the following general scheme:

2H—[O—(CHR¹)ₐ—C(═O)]_{w}—N(R²)—R³—N(R²)—[C(═O)—(CHR¹)ₐ—O]ₓ—H+HO—C(═O)—R⁴—C(═O)—[N(R⁵)—R⁶—N(R⁵)—C(═O)—R⁴—C(═O)]_{c}—OH→
H—[O—(CHR¹)ₐ—C(═O)]_{w}—N(R²—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O₂]_{z}—H+2H₂O;
wherein R¹, R², R³, R⁴, R⁵, R⁶, a, c, w, x, y and z are as defined elsewhere herein.

In particular, the reaction of the amic diacid and oligo(ester-amide) diol may proceed in accordance with the following general scheme:

2H—[O—(CHR¹)ₐ—C(═O)]_{w}—N(R²)—R³—N(R²)—[C(═O)—(CHR¹)ₐ—O]ₓ—H+HO—C(═O)—R⁴—C(═O)—N(R⁵)—R⁶—N(R⁵)—C(═O)—R⁴—C(═O)—OH→
H—[O—(CHR¹)ₐ—C(═O)]_{w}—N(R²)—R³—N(R²)—[C(═O)—(CHR¹)ₐ—O]ₓ—C(═O)—R⁴—C(═O)—N(R⁵)—R⁶—N(R⁵)—C(═O)—R⁴—C(═O)—[O—(CHR¹)ₐ—C(═O)]_{y}—N(R²)—R³—N(R²)—[C(═O)—(CHR¹)ₐ—O]_{z}—H+2H₂O;
wherein R¹, R², R³, R⁴, R⁵, R⁶, a, w, x, y and z are as defined elsewhere herein.

With respect to Reaction IV, the hydroxyl end groups of the hydroxyl-functionalized intermediate may be reacted in various ways to introduce (meth)acryloyl functional groups, thereby providing the desired Type B (meth)acryloyl-functionalized amide-containing oligomer corresponding to structure (He), as described above for oligomers of structure (IIa). For example, the hydroxyl-functionalized intermediate may be reacted with a (meth)acryloyl-functionalizing reagent selected from the group consisting of isocyano-functionalized (meth)acrylates; (meth)acryloyl halides; (meth)acrylic acid; (meth)acrylic anhydride and (meth)acrylic alkyl ester. An alternative synthetic approach would be to react the hydroxyl-functionalized intermediate with an excess of a polyisocyanate (e.g., a diisocyanate, in particular an aliphatic or aromatic diisocyanate such as isophorone diisocyanate or toluene diisocyanate) to obtain an isocyanate-terminated amide-containing oligomer and then react the isocyanate-functionalized amide-containing oligomer with a hydroxyalkyl (meth)acrylate such as hydroxyethyl (meth)acrylate or with a hydroxyalkyl (meth)acrylamide such as hydroxypropyl (meth)acrylamide. Yet another way to functionalize the hydroxyl-functionalized intermediate with (meth)acrylate groups would be to react the hydroxyl-functionalized intermediate with an anhydride such as succinic anhydride to obtain a carboxylic acid-functionalized amide-containing oligomer, which is then reacted with a polyepoxy compound such as a diglycidyl ether and (meth)acrylic acid or with a glycidyl (meth)acrylate.

In particular, the (meth)acryloyl-functionalizing reagent may be selected from (meth)acryloyl halides; (meth)acrylic acid; (meth)acrylic anhydride and (meth)acrylic alkyl ester.

### Structure (IIf)

A Type B (meth)acryloyl-functionalized amide-containing oligomer corresponding to structure (IIf) may, for example, be a reaction product of an amic diacid and an amine-terminated polyamide which has been functionalized with (meth)acryloyl groups, in particular with (meth)acrylate or (meth)acrylamide groups. The amic diacid may be prepared, for example, by reacting a diamine with a cyclic anhydride or a dicarboxylic acid as described above for Structure (IIc). The amine-terminated polyamide may be prepared, for example, by ring-opening addition of a lactam with a diamine in a manner analogous to what has been previously described in connection with the synthesis of Type B oligomers in accordance with structure (IIb). In particular, the amine-terminated polyamide may correspond to the intermediate product of structure (XXIV):

H—[NH—(CHR¹)_{b}—C(═O)]_{w}—N(R²)—R³—N(R²)—[C(═O)—(CHR¹)_{b}—NH]ₓ—H (XXIV)

wherein b, R¹, R², R³, w and x are as defined elsewhere herein.

The steps involved in this method of preparing an oligomer having structure MO in accordance with certain aspects of the invention may be summarized as follows:
I. Diamine+cyclic anhydride (or dicarboxylic acid)→amic diacid;
II. Lactam+diamine→p amine-terminated polyamide of structure (XXIV);
III. Amic diacid+amine-terminated polyamide of structure (XXIV)→amine-functionalized intermediate;
IV. Amine-functionalized intermediate+(meth)acryloyl-functionalizing reagent→Structure (IIf) (meth)acryloyl-functionalized amide-containing oligomer

Reactions I, II and II may be as described above for oligomers of structure (IIe). Reaction IV may be as described above for oligomers of structure (IIb). In particular, the (meth)acryloyl-functionalizing reagent may be selected from (meth)acryloyl halides; (meth)acrylic acid; (meth)acrylic anhydride and (meth)acrylic alkyl ester.

### Structure (IIg)

A Type B (meth)acryloyl-functionalized amide-containing oligomer corresponding to structure (IIg) may be a reaction product of a diisocyanate with a dicarboxylic acid, which is functionalized with (meth)acryloyl groups, in particular with (meth)acrylate groups or (meth)acrylamide groups. For example, the Type B (meth)acryloyl-functionalized amide-containing oligomer of structure (IIg) may be obtained by reacting a diisocyanate with a dicarboxylic acid to obtain an amide-containing oligomer having isocyanate end groups and reaction of the isocyanate end groups to introduce (meth)acryloyl functional groups, in particular (meth)acrylate groups or (meth)acrylamide groups.

The reaction between the diisocyanate and the dicarboxylic acid may yield an amide-containing oligomer having isocyanate end groups. This intermediate product may correspond to structure (XXVIII):

OCN—R⁶—[NH—C(═O)—R⁴—C(═O)—NH—R⁶]ₑ—NCO (XXVIII)

wherein e, R⁴, R⁵ and R⁶ are as defined elsewhere herein.

The R⁴ portion of the dicarboxylic acid may be saturated or unsaturated and may be a hydrocarbyl moiety (containing only carbon and hydrogen atoms) but may contain one or more heteroatoms (such as oxygen atoms) in addition to carbon and hydrogen atoms. R⁴ may be aliphatic or aromatic or may contain both aliphatic and aromatic moieties. R⁴ may be linear or branched and may contain a ring structure such as a cyclohexyl group. In particular, the dicarboxylic acid may be polyester with carboxylic acid end groups obtained by reacting at least one cyclic anhydride or dicarboxylic acid with at least polyol. For example, the dicarboxylic acid could be obtained by reacting succinic anhydride with one or more polyether polyols such as poly(tetramethylene oxide) polyol.

The R⁶ portion of the diisocyanate may be aliphatic or aromatic or may contain both aliphatic and aromatic moieties. R⁴ may be linear or branched and may contain a ring structure such as a cyclohexyl group. In particular, the diisocyanate may be an aliphatic or aromatic diisocyanate such as isophorone diisocyanate or toluene diisocyanate.

The isocyanate end groups may be reacted in various ways to introduce (meth)acryloyl functional groups, thereby providing the desired Type B (meth)acrylate-functionalized amide-containing oligomer corresponding to structure (IIg). For example, the intermediate product may be reacted with a (meth)acryloyl-functionalizing reagent selected from the group consisting of hydroxy-functionalized (meth)acrylates; and hydroxy-functionalized (meth)acrylamides.

If the intermediate product of structure (XXVIII) is reacted with (meth)acrylic acid, the resulting product is an oligomer bearing (meth)acrylamide groups according to structure (IId):

A¹—N(R⁵)—R⁶—N(R⁵)—[C(═O)—R⁴—C(═O)—N(R⁵)—R⁶—N(R⁵)]_{d}—A² (IId)

wherein R⁵ is H,
d is an integer of 1 or more,
A¹ and A² are —C(═O)—CR^{c}═CH₂
R^{c} is H or methyl.

### Curable Compositions Containing (Meth)acryloyl-Functionalized Amide-Containing Oligomers

Although the (meth)acryloyl-functionalized oligomers of the present invention (Type A and/or Type B) may be used by themselves as curable compositions (i.e., compositions capable of being cured to provide polymerized, cured materials), in other aspects of the invention one or more (meth)acryloyl-functionalized amide-containing oligomers in accordance with the invention may be formulated with one or more additives (i.e., substance other than the inventive (meth)acryloyl-functionalized amide-containing oligomers) to provide curable compositions. Such additives may include, for example, reactive diluents, oligomers (especially (meth)acrylate-functionalized oligomers) other than (meth)acrylate-functionalized amide-containing oligomers in accordance with the present invention, stabilizers, initiators (including photoinitiators), light blockers, fillers, pigments and the like and combinations thereof. Any of the additives known or used in the curable (meth)acryloyl resin art may also be employed in connection with the (meth)acryloyl-functionalized amide-containing oligomers of the present invention to formulate curable compositions useful for a wide variety of end use applications. Certain of such additives are discussed in more detail below.

### Additional Reactive Components

Curable compositions may be formulated to include one or more additional components capable of reacting with the (meth)acryloyl-functionalized amide-containing oligomers which are in accordance with the present invention. That is, such additional components become covalently bonded into the polymeric matrix formed upon curing of the curable composition. Such additional reactive components typically contain one or more ethylenically unsaturated functional groups per molecule, in particular one or more (meth)acryloyl functional groups per molecule, more particularly one or more (meth)acrylate functional groups per molecule. The additional reactive components may be monomeric or oligomeric in character, as described below in more detail.

The relative amounts of (meth)acryloyl-functionalized oligomer(s) in accordance with the present invention and additional reactive components (such as other (meth)acryloyl-functionalized compounds) in the curable composition is not considered to be critical and may be varied widely, depending upon the particular components selected for use and the properties sought in the curable composition and the cured composition obtained therefrom. For example, the curable composition may be comprised of 0.5 to 99.5% by weight (meth)acrylate-functionalized oligomer in accordance with the present invention and 0.5 to 99.5% by weight additional reactive components, based on the total weight of (meth)acrylate-functionalized oligomer in accordance with the invention and additional reactive components.

Suitable (meth)acryloyl-functionalized compounds include both (meth)acryloyl-functionalized monomers and (meth)acryloyl-functionalized oligomers, in particular (meth)acrylate-functionalized monomers and (meth)acrylate-functionalized oligomers.

According to certain embodiments of the invention, the curable composition comprises, in addition to at least one (meth)acryloyl-functionalized oligomer in accordance with the invention, at least one (meth)acrylate-functionalized monomer containing one, two or more (meth)acrylate functional groups per molecule. Examples of useful (meth)acrylate-functionalized monomers containing two or more (meth)acrylate functional groups per molecule include acrylate and methacrylate esters of polyhydric alcohols (organic compounds containing two or more, e.g., 2 to 6, hydroxyl groups per molecule). Specific examples of suitable polyhydric alcohols include C₂₋₂₀ alkylene glycols (glycols having a C₂₋₁₀ alkylene group may be preferred, in which the carbon chain may be branched; e.g., ethylene glycol, trimethylene glycol, 1,2-propylene glycol, 1,2-butanediol, 1,3-butanediol, 2,3-butanediol, tetramethylene glycol (1,4-butanediol), 1,5-pentanediol, 1,6-hexanediol, 1,8-octanediol, 1,9-nonanediol, 1,12-dodecanediol, cyclohexane-1,4-dimethanol, bisphenols, and hydrogenated bisphenols, as well as alkoxylated (e.g., ethoxylated and/or propoxylated) derivatives thereof, wherein for example from 1 to 20 moles of an alkylene oxide such as ethylene oxide and/or propylene oxide has been reacted with 1 mole of glycol), diethylene glycol, glycerin, alkoxylated glycerin, triethylene glycol, dipropylene glycol, tripropylene glycol, trimethylolpropane, alkoxylated trimethylolpropane, ditrimethylolpropane, alkoxylated ditrimethylolpropane, pentaerythritol, alkoxylated pentaerythritol, dipentaerythritol, alkoxylated dipentaerythritol, cyclohexanediol, alkoxylated cyclohexanediol, cyclohexanedimethanol, alkoxylated cyclohexanedimethanol, norbornene dimethanol, alkoxylated norbornene dimethanol, norbornane dimethanol, alkoxylated norbornane dimethanol, polyols containing an aromatic ring, cyclohexane-1,4-dimethanol ethylene oxide adducts, bis-phenol ethylene oxide adducts, hydrogenated bisphenol ethylene oxide adducts, bisphenol propylene oxide adducts, hydrogenated bisphenol propylene oxide adducts, cyclohexane-1,4-dimethanol propylene oxide adducts, sugar alcohols and alkoxylated sugar alcohols. Such polyhydric alcohols may be fully or partially esterified (with (meth)acrylic acid, (meth)acrylic anhydride, (meth)acryloyl chloride or the like). As used herein, the term “alkoxylated” refers to compounds in which one or more epoxides such as ethylene oxide and/or propylene oxide have been reacted with active hydrogen-containing groups (e.g., hydroxyl groups) of a base compound, such as a polyhydric alcohol, to form one or more oxyalkylene moieties. For example, from 1 to 25 moles of epoxide may be reacted per mole of base compound. According to certain aspects of the invention, the (meth)acrylate-functionalized monomer(s) used may be relatively low in molecular weight (e.g., 100 to 1000 g/mol).

Any of the (meth)acrylate-functionalized oligomers known in the art may also be used in curable compositions of the present invention, provided the curable composition contains at least one (meth)acryloyl-functionalized amide-containing oligomer that is in accordance with the invention. According to certain embodiments, such oligomers contain two or more (meth)acrylate functional groups per molecule. The number average molecular weight of such oligomers may vary widely, e.g., from about 500 to about 50,000 g/mol.

Suitable (meth)acrylate-functionalized oligomers include, for example, polyester (meth)acrylate oligomers, epoxy (meth)acrylate oligomers, polyether (meth)acrylate oligomers, polyurethane (meth)acrylate oligomers, acrylic (meth)acrylate oligomers, polydiene (meth)acrylate oligomers, polycarbonate (meth)acrylate oligomers and combinations thereof. Such oligomers may be selected and used in combination with one or more (meth)acrylate-functionalized monomers in order to enhance the flexibility, strength and/or modulus, among other attributes, of a cured resin prepared using the curable compositions of the present invention.

Exemplary polyester (meth)acrylate oligomers include the reaction products of acrylic or methacrylic acid or mixtures thereof with hydroxyl group-terminated polyester polyols. The reaction process may be conducted such that all or essentially all of the hydroxyl groups of the polyester polyol have been (meth)acrylated, particularly in cases where the polyester polyol is difunctional. The polyester polyols can be made by polycondensation reactions of polyhydroxyl functional components (in particular, diols) and polycarboxylic acid functional compounds (in particular, dicarboxylic acids and anhydrides). The polyhydroxyl functional and polycarboxylic acid functional components can each have linear, branched, cycloaliphatic or aromatic structures and can be used individually or as mixtures.

Examples of suitable epoxy (meth)acrylate oligomers include the reaction products of acrylic or methacrylic acid or mixtures thereof with glycidyl ethers or esters. For example, the glycidyl ether may be a polyglycidyl ether of a bisphenol such as bisphenol A or oligomer thereof.

Suitable polyether (meth)acrylate oligomers include, but are not limited to, the condensation reaction products of acrylic or methacrylic acid or mixtures thereof with polyetherols which are polyether polyols (such as polyethylene glycol, polypropylene glycol or polytetramethylene glycol). Suitable polyetherols can be linear or branched substances containing ether bonds and terminal hydroxyl groups. Polyetherols can be prepared by ring opening polymerization of cyclic ethers such as tetrahydrofuran or alkylene oxides with a starter molecule. Suitable starter molecules include water, polyhydroxyl functional materials, polyester polyols and amines.

Polyurethane (meth)acrylate oligomers (sometimes also referred to as “urethane (meth)acrylate oligomers”) capable of being used in the curable compositions of the present invention include urethanes based on aliphatic and/or aromatic polyester polyols and polyether polyols and aliphatic and/or aromatic polyester diisocyanates and polyether diisocyanates capped with (meth)acrylate end-groups. Suitable polyurethane (meth)acrylate oligomers include, for example, aliphatic polyester-based urethane di- and tetra-acrylate oligomers, aliphatic polyether-based urethane di- and tetra-acrylate oligomers, as well as aliphatic polyester/polyether-based urethane di- and tetra-acrylate oligomers.

In various embodiments, the polyurethane (meth)acrylate oligomers may be prepared by reacting aliphatic and/or aromatic diisocyanates with OH group terminated polyester polyols (including aromatic, aliphatic and mixed aliphatic/aromatic polyester polyols), polyether polyols, polycarbonate polyols, polycaprolactone polyols, polyorganosiloxane polyols (e.g., polydimethylsiloxane polyols), or polydiene polyols (e.g., polybutadiene polyols), or combinations thereof to form isocyanate-functionalized oligomers which are then reacted with hydroxyl-functionalized (meth)acrylates such as hydroxyethyl acrylate or hydroxyethyl methacrylate to provide terminal (meth)acrylate groups. For example, the polyurethane (meth)acrylate oligomers may contain two, three, four or more (meth)acrylate functional groups per molecule.

Suitable acrylic (meth)acrylate oligomers (sometimes also referred to in the art as “acrylic oligomers”) include oligomers which may be described as substances having an oligomeric acrylic backbone which is functionalized with one or (meth)acrylate groups (which may be at a terminus of the oligomer or pendant to the acrylic backbone). The acrylic backbone may be a homopolymer, random copolymer or block copolymer comprised of repeating units of acrylic monomers. The acrylic monomers may be any monomeric (meth)acrylate such as C1-C6 alkyl (meth)acrylates as well as functionalized (meth)acrylates such as (meth)acrylates bearing hydroxyl, carboxylic acid and/or epoxy groups. Acrylic (meth)acrylate oligomers may be prepared using any procedures known in the art, such as by oligomerizing monomers, at least a portion of which are functionalized with hydroxyl, carboxylic acid and/or epoxy groups (e.g., hydroxyalkyl(meth)acrylates, (meth)acrylic acid, glycidyl (meth)acrylate) to obtain a functionalized oligomer intermediate, which is then reacted with one or more (meth)acrylate-containing reactants to introduce the desired (meth)acrylate functional groups.

According to certain embodiments of the invention, the curable composition comprises, in addition to at least one (meth)acryloyl-functionalized oligomer in accordance with the invention, at least one (meth)acrylamide-functionalized monomer or oligomer containing at least one (meth)acrylamide functional groups per molecule. Examples of suitable (meth)acrylamide-functionalized monomers and oligomers include acrylamide, methacrylamide, N-hydroxymethyl (meth)acrylamide, N-(2-hydroxyethyl) (meth)acrylamide, N-methyl-N-(2-hydroxyethyl) (meth)acrylamide, N-(2-methoxyethyl) (meth)acrylamide, N-(2-ethoxyethyl) (meth)acrylamide, N-(2-hydroxypropyl) (meth)acrylamide, N-(3-hydroxypropyl) (meth)acrylamide, N-(2,3-dihyroxypropyl) (meth)acrylamide, N-(3-methoxypropyl) (meth)acrylamide, N-methyl (meth)acrylamide, N,N-dimethyl (meth)acrylamide, N-ethyl (meth)acrylamide, N,N-diethyl (meth)acrylamide, N-propyl (meth)acrylamide, N-n-butyl (meth)acrylamide, N-tert-butyl (meth)acrylamide, N,N′-methylene bis(meth)acrylamide, N,N′-ethylene bis(meth)acrylamide, N,N′-hexamethylene bis(meth)acrylamide, polyethylene glycol bis(meth)acrylamide and combinations thereof.

Exemplary (meth)acryloyl-functionalized monomers and oligomers may include (meth)acrylamides, such as acrylamide, methacrylamide and hydroxypropyl methacrylamide; ethoxylated bisphenol A di(meth)acrylates; triethylene glycol di(meth)acrylate; ethylene glycol di(meth)acrylate; tetraethylene glycol di(meth)acrylate; polyethylene glycol di(meth)acrylates; 1,4-butanediol diacrylate; 1,4-butanediol dimethacrylate; diethylene glycol diacrylate; diethylene glycol dimethacrylate, 1,6-hexanediol diacrylate; 1,6-hexanediol dimethacrylate; neopentyl glycol diacrylate; neopentyl glycol di(meth)acrylate; polyethylene glycol (600) dimethacrylate (where 600 refers to the approximate number average molecular weight of the polyethylene glycol portion); polyethylene glycol (200) diacrylate; 1,12-dodecanediol dimethacrylate; tetraethylene glycol diacrylate; triethylene glycol diacrylate, 1,3-butylene glycol dimethacrylate, tripropylene glycol diacrylate, polybutadiene diacrylate; methyl pentanediol diacrylate; polyethylene glycol (400) diacrylate; ethoxylated₂ bisphenol A dimethacrylate; ethoxylated₃ bisphenol A dimethacrylate; ethoxylated₃ bisphenol A diacrylate; cyclohexane dimethanol dimethacrylate; cyclohexane dimethanol diacrylate; ethoxylated₁₀ bisphenol A dimethacrylate (where the numeral following “ethoxylated” is the average number of oxyalkylene moieties per molecule); dipropylene glycol diacrylate; ethoxylated₄ bisphenol A dimethacrylate; ethoxylated₆ bisphenol A dimethacrylate; ethoxylated₈ bisphenol

A dimethacrylate; alkoxylated hexanediol diacrylates; alkoxylated cyclohexane dimethanol diacrylate; dodecane diacrylate; ethoxylated₄ bisphenol A diacrylate; ethoxylated₁₀ bisphenol A diacrylate; polyethylene glycol (400) dimethacrylate; polypropylene glycol (400) dimethacrylate; metallic diacrylates; modified metallic diacrylates; metallic dimethacrylates; polyethylene glycol (1000) dimethacrylate; methacrylated polybutadiene; propoxylated₂ neopentyl glycol diacrylate; ethoxylated₃₀ bisphenol A dimethacrylate; ethoxylated₃₀ bisphenol A diacrylate; alkoxylated neopentyl glycol diacrylates; polyethylene glycol dimethacrylates; 1,3-butylene glycol diacrylate; ethoxylated₂ bisphenol A dimethacrylate; dipropylene glycol diacrylate; ethoxylated₄ bisphenol A diacrylate; polyethylene glycol (600) diacrylate; polyethylene glycol (1000) dimethacrylate; tricyclodecane dimethanol diacrylate; propoxylated₂ neopentyl glycol diacrylate; diacrylates of alkoxylated aliphatic alcohols trimethylolpropane trimethacrylate; trimethylolpropane triacrylate; tris (2-hydroxyethyl) isocyanurate triacrylate; ethoxylated₂₀ trimethylolpropane triacrylate; pentaerythritol triacrylate; ethoxylated₃ trimethylolpropane triacrylate; propoxylated₃ trimethylolpropane triacrylate; ethoxylated₆ trimethylolpropane triacrylate; propoxylated₆ trimethylolpropane triacrylate; ethoxylated₉ trimethylolpropane triacrylate; alkoxylated trifunctional acrylate esters; trifunctional methacrylate esters; trifunctional acrylate esters; propoxylated₃ glyceryl triacrylate; propoxylated_{5.5} glyceryl triacrylate; ethoxylated₁₅ trimethylolpropane triacrylate; trifunctional phosphoric acid esters; trifunctional acrylic acid esters; pentaerythritol tetraacrylate; di-trimethylolpropane tetraacrylate; ethoxylated₄ pentaerythritol tetraacrylate;

pentaerythritol polyoxyethylene tetraacrylate; dipentaerythritol pentaacrylate; pentaacrylate esters; epoxy acrylate oligomers; epoxy methacrylate oligomers; urethane acrylate oligomers; urethane methacrylate oligomers; polyester acrylate oligomers; polyester methacrylate oligomers; stearyl methacrylate oligomer; acrylic acrylate oligomers; perfluorinated acrylate oligomers; perfluorinated methacrylate oligomers; amino acrylate oligomers; amine-modified polyether acrylate oligomers; and amino methacrylate oligomers.

The curable compositions of the present invention may optionally comprise one or more (meth)acrylate-functionalized compounds containing a single acrylate or methacrylate functional group per molecule (referred to herein as “mono(meth)acrylate-functionalized compounds”). Any of such compounds known in the art may be used.

Examples of suitable mono(meth)acrylate-functionalized compounds include, but are not limited to, mono-(meth)acrylate esters of aliphatic alcohols (wherein the aliphatic alcohol may be straight chain, branched or alicyclic and may be a mono-alcohol, a di-alcohol or a polyalcohol, provided only one hydroxyl group is esterified with (meth)acrylic acid); mono-(meth)acrylate esters of aromatic alcohols (such as phenols, including alkylated phenols); mono-(meth)acrylate esters of alkylaryl alcohols (such as benzyl alcohol); mono-(meth)acrylate esters of oligomeric and polymeric glycols such as diethylene glycol, triethylene glycol, dipropylene glycol, tripropylene glycol, polyethylene glycol, and polypropylene glycol); mono-(meth)acrylate esters of monoalkyl ethers of glycols, oligomeric glycols, polymeric glycols; mono-(meth)acrylate esters of alkoxylated (e.g., ethoxylated and/or propoxylated) aliphatic alcohols (wherein the aliphatic alcohol may be straight chain, branched or alicyclic and may be a mono-alcohol, a di-alcohol or a polyalcohol, provided only one hydroxyl group of the alkoxylated aliphatic alcohol is esterified with (meth)acrylic acid); mono-(meth)acrylate esters of alkoxylated (e.g., ethoxylated and/or propoxylated) aromatic alcohols (such as alkoxylated phenols); caprolactone mono(meth)acrylates; and the like.

The following compounds are specific examples of mono(meth)acrylate-functionalized compounds suitable for use in the curable compositions of the present invention: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; isobornyl (meth)acrylate; 2-(2-ethoxyethoxy)ethyl (meth)acrylate; cyclohexyl (meth)acrylate; glycidyl (meth)acrylate; isodecyl (meth)acrylate: 2-phenoxyethyl (meth)acrylate: lauryl (meth)acrylate; isobornyl (meth)acrylate; 2-phenoxyethyl (meth)acrylate; alkoxylated phenol (meth)acrylates; alkoxylated nonylphenol (meth)acrylates; cyclic trimethylolpropane formal (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; and combinations thereof.

According to one aspect of the invention, the one or more reactive components of the curable composition which are used in combination with the (meth)acryloyl-functionalized oligomer of the present invention are selected so as to provide a homogeneous curable composition, i.e., a curable composition that is a single phase (in particular, a single phase at 25° C.). Such one or more reactive components, in particular one or more (meth)acryloyl-functionalized monomers, more particularly one or more (meth)acrylate-functionalized monomers, may also be selected so as to provide a curable composition that is liquid at 25° C. One or more of such reactive components may function as reactive diluents, thereby lowering the viscosity of the curable composition.

### Stabilizer

Generally speaking, if the curable compositions of the present invention are to be stored for a length of time before being used, it will be desirable to include one or more stabilizers in order to provide adequate storage stability and shelf life. As used herein, the term “stabilizer” means a compound or substance which retards or prevents reaction or curing of (meth)acryloyl functional groups present in a composition in the absence of actinic radiation.

However, it will be advantageous to select an amount and type of stabilizer such that the composition remains capable of being cured when exposed to actinic radiation (that is, the stabilizer does not prevent radiation curing of the composition). Typically, effective stabilizers for purposes of the present invention will be classified as free radical stabilizers (i.e., stabilizers which function by inhibiting free radical reactions).

Any of the stabilizers known in the art related to (meth)acryloyl-functionalized compounds may be utilized in the present invention. Quinones represent a particularly preferred type of stabilizer which can be employed in the context of the present invention. As used herein, the term “quinone” includes both quinones and hydroquinones as well as ethers thereof such as monoalkyl, monoaryl, monoaralkyl and bis(hydroxyalkyl) ethers of hydroquinones. Hydroquinone monomethyl ether is an example of a suitable stabilizer which can be utilized.

The concentration of stabilizer in the curable composition will vary depending upon the particular stabilizer or combination of stabilizers selected for use and also on the degree of stabilization desired and the susceptibility of components in the curable compositions towards degradation in the absence of stabilizer. Typically, however, the curable composition is formulated to comprise from 50 to 5000 ppm stabilizer.

### Photoinitiator

In certain embodiments of the invention, the curable compositions described herein include at least one photoinitiator and are curable with radiant energy. A photoinitiator may be considered any type of substance that, upon exposure to radiation (e.g., actinic radiation), forms species that initiate the reaction and curing of polymerizing organic substances present in the curable composition (including (meth)acryloyl-functionalized amide-containing oligomers in accordance with the invention). Suitable photoinitiators include both free radical photoinitiators as well as cationic photoinitiators and combinations thereof.

Free radical polymerization initiators are substances that form free radicals when irradiated. The use of free radical photoinitiators is especially preferred. Non-limiting types of free radical photoinitiators suitable for use in the curable compositions of the present invention include, for example, benzoins, benzoin ethers, acetophenones, benzyl, benzyl ketals, anthraquinones, phosphine oxides, a-hydroxyketones, phenylglyoxylates, a-aminoketones, benzophenones, thioxanthones, xanthones, acridine derivatives, phenazene derivatives, quinoxaline derivatives and triazine compounds.

The amount of photoinitiator may be varied as may be appropriate depending upon the photoinitiator(s) selected, the amounts and types of polymerizable species present in the curable composition, the radiation source and the radiation conditions used, among other factors. Typically, however, the amount of photoinitiator may be from 0.05% to 5%, preferably 0.1% to 2% by weight, based on the total weight of the curable composition.

### Other Additives

The curable compositions of the present invention may optionally contain one or more additives instead of or in addition to the above-mentioned ingredients. Such additives include, but are not limited to, antioxidants/photostabilizers, light blockers/absorbers, polymerization inhibitors, foam inhibitors, flow or leveling agents, colorants, pigments, dispersants (wetting agents, surfactants), slip additives, fillers, chain transfer agents, thixotropic agents, matting agents, impact modifiers, waxes or other various additives, including any of the additives conventionally utilized in the coating, sealant, adhesive, molding, 3D printing or ink arts.

The curable compositions of the present invention may comprise one or more light blockers (sometimes referred to in the art as absorbers), particularly where the curable composition is to be used as a resin in a three-dimensional printing method involving photocuring of the curable composition. The light blocker(s) may be any such substances known in the three-dimensional printing art, including for example non-reactive pigments and dyes. The light blocker may be a visible light blocker or a UV light blocker, for example. Examples of suitable light blockers include, but are not limited to, titanium dioxide, carbon black and organic ultraviolet light absorbers such as hydroxybenzophenone, hydroxyphenylbenzotriazole, oxanilide, benzophenone, thioxanthone, hydroxyphenyltriazine,

Sudan I, bromothymol blue, 2,2′-(2,5-thiophenediyl)bis(5-tert-butylbenzoxazole) (sold under the brand name “Benetex OB Plus”) and benzotriazole ultraviolet light absorbers.

The amount of light blocker may be varied as may be desired or appropriate for particular applications. Generally speaking, if the curable composition contains light blocker, it is present in a concentration of from 0.001 to 10% by weight based on the weight of the curable composition.

Advantageously, the curable compositions of the present invention may be formulated to be solvent-free, i.e., free of any non-reactive volatile substances (substances having a boiling point at atmospheric pressure of 150° C. or less). For example, the curable compositions of the present invention may contain little or no non-reactive solvent, e.g., less than 10% or less than 5% or less than 1% or even 0% non-reactive solvent, based on the total weight of the curable composition.

### Uses for the (Meth)acryloyl-Functionalized Amide-Containing Oligomers of the Invention and Curable Compositions Containing Such (Meth)acryloyl-Functionalized Amide-Containing Oligomers

As previously mentioned, curable compositions in accordance with the present invention may contain one or more photoinitiators and may be photocurable. In certain other embodiments of the invention, the curable compositions described herein do not include any initiator and are curable (at least in part) with electron beam energy. In other embodiments, the curable compositions described herein include at least one free radical initiator that decomposes when heated or in the presence of an accelerator and are curable chemically (i.e., without having to expose the curable composition to radiation). The at least one free radical initiator that decomposes when heated or in the presence of an accelerator may, for example, comprise a peroxide or azo compound. Suitable peroxides for this purpose may include any compound, in particular any organic compound, that contains at least one peroxy (—O—O—) moiety, such as, for example, dialkyl, diaryl and aryl/alkyl peroxides, hydroperoxides, percarbonates, peresters, peracids, acyl peroxides and the like. The at least one accelerator may comprise, for example, at least one tertiary amine and/or one or more other reducing agents based on metal-containing salts (such as, for example, carboxylate salts of transition metals such as iron, cobalt, manganese, vanadium and the like and combinations thereof). The accelerator(s) may be selected so as to promote the decomposition of the free radical initiator at room or ambient temperature to generate active free radical species, such that curing of the curable composition is achieved without having to heat or bake the curable composition. In other embodiments, no accelerator is present and the curable composition is heated to a temperature effective to cause decomposition of the free radical initiator and to generate free radical species which initiate curing of the polymerizable compound(s) present in the curable composition.

Advantageously, the curable compositions of the present invention may be formulated to be solvent-free, i.e., free of any non-reactive volatile substances (substances having a boiling point at atmospheric pressure of 150° C. or less). For example, the curable compositions of the present invention may contain little or no non-reactive solvent, e.g., less than 10% or less than 5% or less than 1% or even 0% non-reactive solvent, based on the total weight of the curable composition. If reactive diluents are utilized in the curable composition, they may be selected so as to render the curable composition sufficiently low in viscosity, even without solvent being present, that the curable composition can be easily applied at a suitable application temperature to a substrate surface so as to form a relatively thin, uniform layer.

In preferred embodiments of the invention, the curable composition is a liquid at 25° C. In various embodiments of the invention, the curable compositions described herein are formulated to have a viscosity of less than 10,000 mPa·s (cP), or less than 5000 mPa·s (cP), or less than 4000 mPa·s (cP), or less than 3000 mPa·s (cP), or less than 2500 mPa·s (cP), or less than 2000 mPa·s (cP), or less than 1500 mPa·s (cP), or less than 1000 mPa·s (cP) or even less than 500 mPa·s (cP) as measured at 25° C. using a Brookfield viscometer, model DV-II, using a 27 spindle (with the spindle speed varying typically between 20 and 200 rpm, depending on viscosity). In advantageous embodiments of the invention, the viscosity of the curable composition is from 200 to 5000 mPa·s (cP), or from 200 to 2000 mPa·s (cP), or from 200 to 1500 mPa·s (cP), or from 200 to 1000 mPa·s (cP) at 25° C. However, relatively high viscosities can provide satisfactory performance in applications where the curable composition is heated above 25° C., such as in three-dimensional printing operations or the like which employ machines having heated resin vats. It is even possible to formulate the curable compositions such that they are solids at 25° C., but are capable of being liquefied upon heating to the temperature at which they are to be processed to form useful cured articles.

The curable compositions described herein may be compositions that are to be subjected to curing by means of free radical polymerization, cationic polymerization or other types of polymerization. In particular embodiments, the curable compositions are photocured (i.e., cured by exposure to actinic radiation such as light, in particular visible or UV light). End use applications for the curable compositions include, but are not limited to, inks, coatings, adhesives, additive manufacturing resins (such as 3D printing resins), molding resins, sealants, composites, antistatic layers, electronic applications, recyclable materials, smart materials capable of detecting and responding to stimuli, and biomedical materials.

Cured compositions prepared from curable compositions as described herein may be used, for example, in three-dimensional articles (wherein the three-dimensional article may consist essentially of or consist of the cured composition), coated articles (wherein a substrate is coated with one or more layers of the cured composition, including encapsulated articles in which a substrate is completely encased by the cured composition), laminated or adhered articles (wherein a first component of the article is laminated or adhered to a second component by means of the cured composition), composite articles or printed articles (wherein graphics or the like are imprinted on a substrate, such as a paper, plastic or metal-containing substrate, using the cured composition).

Curing of the curable compositions in accordance with the present invention may be carried out by any suitable method, such as free radical and/or cationic polymerization. One or more initiators, such as a free radical initiator (e.g., photoinitiator, peroxide initiator) may be present in the curable composition. Prior to curing, the curable composition may be applied to a substrate surface in any known conventional manner, for example, by spraying, knife coating, roller coating, casting, drum coating, dipping, and the like and combinations thereof. Indirect application using a transfer process may also be used. A substrate may be any commercially relevant substrate, such as a high surface energy substrate or a low surface energy substrate, such as a metal substrate or plastic substrate, respectively. The substrates may comprise metal, paper, cardboard, glass, thermoplastics such as polyolefins, polycarbonate, acrylonitrile butadiene styrene (ABS), and blends thereof, composites, wood, leather and combinations thereof. When used as an adhesive, the curable composition may be placed between two substrates and then cured, the cured composition thereby bonding the substrates together to provide an adhered article. Curable compositions in accordance with the present invention may also be formed or cured in a bulk manner (e.g., the curable composition may be cast into a suitable mold and then cured).

Curing may be accelerated or facilitated by supplying energy to the curable composition, such as by heating the curable composition and/or by exposing the curable composition to a radiation source, such as visible or UV light, infrared radiation, and/or electron beam radiation. Thus, the cured composition may be deemed the reaction product of the curable composition, formed by curing. A curable composition may be partially cured by exposure to actinic radiation, with further curing being achieved by heating the partially cured article. For example, an article formed from the curable composition (e.g., a 3D printed article) may be heated at a temperature of from 40° C. to 120° C. for a period of time of from 5 minutes to 12 hours.

A plurality of layers of a curable composition in accordance with the present invention may be applied to a substrate surface; the plurality of layers may be simultaneously cured (by exposure to a single dose of radiation, for example) or each layer may be successively cured before application of an additional layer of the curable composition.

The curable compositions which are described herein can be used as resins in three-dimensional printing and other additive manufacturing applications. Three-dimensional (3D) printing is a process in which a 3D digital model is manufactured by the accretion of construction material. The 3D printed object is created by utilizing the computer-aided design (CAD) data of an object through sequential construction of two dimensional (2D) layers or slices that correspond to cross-sections of 3D objects. Stereolithography (SL) is one type of additive manufacturing where a liquid resin is hardened by selective exposure to a radiation to form each 2D layer. The radiation can be in the form of electromagnetic waves or an electron beam. The most commonly applied energy source is ultraviolet, visible or infrared radiation.

The inventive curable compositions described herein may be used as additive manufacturing (e.g., 3D printing) resin formulations, that is, compositions intended for use in manufacturing three-dimensional articles using additive manufacturing (e.g., 3D printing) techniques. Such three-dimensional articles may be free-standing/self-supporting and may consist essentially of or consist of a composition in accordance with the present invention that has been cured. The three-dimensional article may also be a composite, comprising at least one component consisting essentially of or consisting of a cured composition as previously mentioned as well as at least one additional component comprised of one or more materials other than such a cured composition (for example, a metal component or a thermoplastic component). The curable compositions of the present invention are particularly useful in digital light printing (DLP), although other types of additive manufacturing (including three-dimensional (3D) printing) methods may also be practiced using the inventive curable compositions (e.g., SLA, inkjet). The curable compositions of the present invention may be used in a three-dimensional printing operation together with another material which functions as a scaffold or support for the article formed from the curable composition of the present invention.

Thus, the curable compositions of the present invention are useful in the practice of various types of three-dimensional fabrication or printing techniques, including methods in which construction of a three-dimensional object is performed in a step-wise or layer-by-layer manner. In such methods, layer formation may be performed by solidification (curing) of the curable composition under the action of exposure to radiation, such as visible, UV or other actinic irradiation. For example, new layers may be formed at the top surface of the growing object or at the bottom surface of the growing object. The curable compositions of the present invention may also be advantageously employed in methods for the production of three-dimensional objects by additive manufacturing wherein the method is carried out continuously. For example, the object may be produced from a liquid interface. Suitable methods of this type are sometimes referred to in the art as “continuous liquid interface (or interphase) product (or printing)” (“CLIP”) methods. Such methods are described, for example, in WO 2014/126830; WO 2014/126834; WO 2014/126837; and Tumbleston et al., “Continuous Liquid Interface Production of 3D Objects,” Science Vol. 347, Issue 6228, pp. 1349-1352 (Mar. 20, 2015), the entire disclosure of which is incorporated herein by reference in its entirety for all purposes.

When stereolithography is conducted above an oxygen-permeable build window, the production of an article using a curable composition in accordance with the present invention may be enabled in a CLIP procedure by creating an oxygen-containing “dead zone” which is a thin uncured layer of the curable composition between the window and the surface of the cured article as it is being produced. In such a process, a curable composition is used in which curing (polymerization) is inhibited by the presence of molecular oxygen; such inhibition is typically observed, for example, in curable compositions which are capable of being cured by free radical mechanisms. The dead zone thickness which is desired may be maintained by selecting various control parameters such as photon flux and the optical and curing properties of the curable composition. The CLIP process proceeds by projecting a continuous sequence of actinic radiation (e.g., UV) images (which may be generated by a digital light-processing imaging unit, for example) through an oxygen-permeable, actinic radiation- (e.g., UV-) transparent window below a bath of the curable composition maintained in liquid form. A liquid interface below the advancing (growing) article is maintained by the dead zone created above the window. The curing article is continuously drawn out of the curable composition bath above the dead zone, which may be replenished by feeding into the bath additional quantities of the curable composition to compensate for the amounts of curable composition being cured and incorporated into the growing article.

### Aspects of the Invention

Illustrative, non-limiting embodiments of the present invention may be summarized as follows:

Aspect 1: A (meth)acrylate-functionalized amide-containing oligomer, wherein the (meth)acrylate-functionalized amide-containing oligomer either:
i.) comprises at least one polyamide block and at least one non-polyamide block and is substituted with at least one (meth)acrylate functional group; or
ii.) has structure (IIa) or structure (IIe) or structure (IIf):

A¹—[O(CHR¹)_{z}C(═O)]_{w}—N(R²)—R³—N(R²)—[C(═O)(CHR¹)ₐO]ₓ—A² (IIa);

A¹—[O—(CHR¹)ₐ—C(═O)]_{w}—N(R²)—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O]_{z}—A² (IIe);

A¹—[NH—(CHR¹)_{b}—C(═O)]_{w}—NH—R³—NH—[C(═O)—(CHR¹)_{b}—NH]ₓ—C(═O)—R⁴—C(═O)—[N(R⁵)—R⁶—N(R⁵)—C(═O)—R⁴—C(═O)]ₓ—[NH—(CHR¹)_{b}—C(═O)]_{y}—NH—R³—NH—[C(═O)—(CHR¹)_{b}—NH]_{z}—A² (IIf);

wherein A¹ and A² are the same or different and are (meth)acryloyl-containing moieties, a is an integer of 2 to 5, w, x, y and z are the same or different and are each an integer of 1 or more, R¹, R² and R⁵ are the same or different and are each H or an alkyl group, and R³, R⁴ and R6 are the same or different and are each a divalent organic moiety.

Aspect 2: The (meth)acrylate-functionalized amide-containing oligomer of Aspect 1, wherein the (meth)acrylate-functionalized amide-containing oligomer comprises at least one polyamide block and at least one non-polyamide block and the at least one polyamide block comprises at least one polyamide block selected from the group consisting of polyamide 6,6 blocks; polyamide 6,10 blocks; polyamide 10,10 blocks; polyamide 6,12 blocks; polyamide 4,6 blocks; polyamide 6 blocks; polyamide 11 blocks; and polyamide 12 blocks.

Aspect 3: The (meth)acrylate-functionalized amide-containing oligomer of either Aspect 1 or Aspect 2, wherein the (meth)acrylate-functionalized amide-containing oligomer comprises at least one polyamide block and at least one non-polyamide block and each polyamide block has a number average molecular weight of 500 daltons to 75,000 daltons.

Aspect 4: The (meth)acrylate-functionalized amide-containing oligomer of any of Aspects 1-3, wherein the (meth)acrylate-functionalized amide-containing oligomer comprises at least two polyamide blocks and at least one non-polyamide block.

Aspect 5: The (meth)acrylate-functionalized amide-containing oligomer of any of Aspects 1-4, wherein the (meth)acrylate-functionalized amide-containing oligomer comprises at least one polyamide block and at least one non-polyamide block and the at least one non-polyamide block is selected from the group consisting of polyether blocks, polyester blocks, polyether-ester blocks, polycarbonate blocks, polydiene blocks and polyorganosiloxane blocks.

Aspect 6: The (meth)acrylate-functionalized amide-containing oligomer of any of

Aspects 1-5, wherein the (meth)acrylate-functionalized amide-containing oligomer comprises at least one polyamide block and at least one non-polyamide block and the at least one non-polyamide block is selected from the group consisting of polyethylene glycol blocks, polypropylene glycol blocks, polytetramethylene glycol blocks, polydimethylsiloxane blocks, and ethoxylated bis-phenol A blocks.

Aspect 7: The (meth)acrylate-functionalized amide-containing oligomer of any of Aspects 1-6, wherein the (meth)acrylate-functionalized amide-containing oligomer comprises at least one polyamide block and at least one non-polyamide block and each non-polyamide block has a number average molecular weight of 1,000 daltons to 75,000 daltons.

Aspect 8: The (meth)acrylate-functionalized amide-containing oligomer of any of Aspects 1-7, wherein the (meth)acrylate-functionalized amide-containing oligomer comprises at least one polyamide block and at least one non-polyamide block and each (meth)acrylate group is substituted at a terminal position of a block copolymer segment comprised of at least one polyamide block and at least one non-polyamide block.

Aspect 9: The (meth)acrylate-functionalized amide-containing oligomer of Aspect 8, wherein the block copolymer segment has structure —(A—B)ₘ— or —(A—B)ₙ—A— wherein each of m and n is an integer of at least 1, A is a polyamide block, and B is a non-polyamide block.

Aspect 10: The (meth)acrylate-functionalized amide-containing oligomer of Aspect 8, wherein the block copolymer segment has structure —A—B—A— wherein A is a polyamide block and B is a non-polyamide block.

Aspect 11: The (meth)acrylate-functionalized amide-containing oligomer of any of Aspects 1-10, wherein the (meth)acrylate-functionalized amide-containing oligomer comprises at least one polyamide block and at least one non-polyamide block and at least one non-polyamide block is a polyether block substituted with a plurality of (meth)acrylate groups.

Aspect 12: The (meth)acrylate-functionalized amide-containing oligomer of any of Aspects 1-11, wherein the (meth)acrylate-functionalized amide-containing oligomer comprises at least one polyamide block and at least one non-polyamide block and the at least one polyamide block has a glass transition temperature of 30° C. or more and the at least one non-polyamide block has a glass transition temperature of 0° C. or less.

Aspect 13: The (meth)acrylate-functionalized amide-containing oligomer of any of Aspects 1-12, wherein the (meth)acrylate-functionalized amide-containing oligomer comprises at least one polyamide block and at least one non-polyamide block and the (meth)acrylate-functionalized amide-containing oligomer is substituted with at least two (meth)acrylate groups.

Aspect 14: The (meth)acrylate-functionalized amide-containing oligomer of any of Aspects 1-13, wherein the (meth)acrylate-functionalized amide-containing oligomer comprises at least one polyamide block and at least one non-polyamide block and the (meth)acrylate-functionalized amide-containing oligomer is substituted with at least one (meth)acrylate group-containing moiety having structure (I):

—N[CH₂CH₂C(═O)OCH₂CH(OH)CH₂OC(═O)C(CH₃)═CH₂]₂ (I).

Aspect 15: The (meth)acrylate-functionalized amide-containing oligomer of any of Aspects 1-15, wherein the (meth)acrylate-functionalized amide-containing oligomer comprises at least one polyamide block and at least one non-polyamide block and the (meth)acrylate-functionalized amide-containing oligomer has a number average molecular weight of 2,000 daltons to 100,000 daltons.

Aspect 16: The (meth)acrylate-functionalized amide-containing oligomer of any of Aspects 1-15, wherein the (meth)acrylate-functionalized amide-containing oligomer comprises at least one polyamide block and at least one non-polyamide block and the (meth)acrylate-functionalized amide-containing oligomer is:
(A) a reaction product of a) an amine- or hydroxyl-functionalized block copolymer comprising at least one polyamide block and at least one non-polyamide block and b) a (meth)acrylate-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; and poly(meth)acrylate-functionalized compounds comprised of at least one acrylate group and at least one methacrylate group;
(B) a reaction product of a) an isocyano-functionalized block copolymer comprising at least one polyamide block and at least one non-polyamide block and b) a hydroxyl-functionalized (meth)acrylate; or
(C) an anionically polymerized lactam end-capped with at least one epoxide comprising at least one epoxy-functional (meth)acrylic monomer.

Aspect 17: A method of making a (meth)acrylate-functionalized amide-containing oligomer in accordance with any of Aspects 1-16 in which the (meth)acrylate-functionalized amide-containing oligomer comprises at least one polyamide block and at least one non-polyamide block, wherein the method comprises:
(A) reacting a) an amine- or hydroxyl-functionalized block copolymer comprising at least one polyamide block and at least one non-polyamide block and b) a (meth)acrylate-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; and poly(meth)acrylate-functionalized compounds;
(B) reacting a) an isocyano-functionalized block copolymer comprising at least one polyamide block and at least one non-polyamide block and b) a hydroxyl-functionalized (meth)acrylate; or
(C) end-capping an anionically polymerized lactam end-capped with at least one epoxide comprising at least one epoxy-functional (meth)acrylic monomer.

Aspect 18: The (meth)acrylate-functionalized amide-containing oligomer of any of Aspects 1-16, wherein the (meth)acrylate-functionalized amide-containing oligomer has structure (IIa) or (IIe) or (IIf) and R¹, R² and R⁵ are each H.

Aspect 19: The (meth)acrylate-functionalized amide-containing oligomer of any of Aspects 1-16 or 18, wherein the (meth)acrylate-functionalized amide-containing oligomer has structure (IIa) and w+x=2-10 or has structure (IIe) or (IIf) and w+x+y+z=4-20.

Aspect 20: The (meth)acrylate-functionalized amide-containing oligomer of any of Aspects 1-16, 18 or 19, wherein the (meth)acrylate-functionalized amide-containing oligomer has structure (IIa) or (IIe) or (IIf), R³ is —CH₂—Ar—CH₂—, wherein Ar is an aromatic group or -Cyclohexyl-CH₂-Cyclohexyl-, wherein Cyclohexyl is a divalent cyclohexyl moiety, which may be substituted or unsubstituted.

Aspect 21: The (meth)acrylate-functionalized amide-containing oligomer of any of Aspects 1-16 or 18-20, wherein the (meth)acrylate-functionalized amide-containing oligomer has structure (IIa) or structure (IIe) or structure (IIf) and A¹ and A² are selected from the group consisting of —C(═O)C(R⁷)═CH₂;

—C(═O)NH—R⁸—NHC(═O)OCH₂CH(R⁹OC(═O)C(R¹⁰)═CH₂; and

—C(═O)CH₂CH₂C(═O)OCH₂CH(OH)CH₂O—R¹¹—O—CH₂CH(OH)CH₂OC(═O)C(R¹²)═CH₂,

wherein R⁷, R⁹, R¹⁹ and R¹² are independently H or methyl, and R⁸ and R¹¹ are each independently a divalent organic moiety.

Aspect 22: The (meth)acrylate-functionalized amide-containing oligomer of any of Aspects 1-16 or 18-21, wherein the (meth)acrylate-functionalized amide-containing oligomer has structure (IIa) and is a reaction product of a lactone and a diamine which is functionalized with (meth)acrylate groups.

Aspect 23: The (meth)acrylate-functionalized amide-containing oligomer of any of Aspects 1-16 or 18-22, wherein the (meth)acrylate-functionalized amide-containing oligomer has structure (IIa) and is obtained by ring-opening addition of a lactone to a diamine to obtain a amide-containing oligomer having hydroxyl end groups and reaction of the hydroxyl end groups to introduce (meth)acrylate functional groups.

Aspect 24: A curable composition comprised of at least one (meth)acrylate-functionalized amide-containing oligomer in accordance with any of Aspects 1-16 or 18-23 and at least one additional component.

Aspect 25: The curable composition of Aspect 24, wherein the at least one additional component comprises at least one (meth)acrylate-functionalized compound in addition to the at least one (meth)acrylate-functionalized amide-containing oligomer.

Aspect 26: The curable composition of Aspect 24 or Aspect 25, wherein the at least one additional component comprises at least one photoinitiator.

Aspect 27: The curable composition of any of Aspects 24-26, wherein the curable composition is selected from the group consisting of adhesives, sealants, coatings, three dimensional printing and additive manufacturing resins, inks and molding resins.

Aspect 28: A method of making a cured polymeric material, wherein the method comprises curing the curable composition of any of Aspects 24-27 using actinic radiation.

Aspect 29: A cured polymeric material obtained in accordance with Aspect 28.

Aspect 30: A method of making a three-dimensional article by additive manufacturing, comprising using the curable composition of any of Aspects 24-27 to manufacture the three-dimensional article.

Within this specification, embodiments have been described in a way which enables a clear and concise specification to be written, but it is intended and will be appreciated that embodiments may be variously combined or separated without departing from the invention.

For example, it will be appreciated that all preferred features described herein are applicable to all aspects of the invention described herein.

In some embodiments, the invention herein can be construed as excluding any element or process step that does not materially affect the basic and novel characteristics of the compositions and methods described herein. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1: Synthesis of a Type B (Meth)Acrylate Functionalized Amide-Containing Oligomer

### Step 1: Preparation of Oligo(Ester-Amide) Diol

A resin kettle equipped with a nitrogen gas inlet, a mechanical stirrer, a thermocouple, and an addition funnel was charged with ε-caprolactone (342.42 g) and heated by means of a heating mantle to 135-140° C. under nitrogen with stirring. While the caprolactone was heating, 210.36 g methylene bis(4-aminocyclohexane) was pre-heated to 60° C. in an oven and charged to the addition funnel. Once the target temperature was reached, the diamine was charged into the caprolactone over the course of 60 minutes. The reaction was allowed to proceed with stirring until all free caprolactone was consumed as determined by TLC or HPLC. The oligo(ester-amide) diol product was transferred to a glass jar and allowed to cool to room temperature, where it formed colorless to slightly yellow needle crystals.

### Step 2: Preparation of Amic Diacid

Separately, a 1.5 L round bottom flask equipped analogously to the resin kettle above but with an added reflux condenser was charged with 150 g of dimethylacetamide and 50 g of succinic anhydride and the stirrer and nitrogen flow were activated. Jeffamine® EDR-148 polyetheramine (37 g) was charged into the addition funnel and added to the stirred anhydride solution over the course of an hour; at the end of the feed, the mixture was heated to 90° C. by means of a mantle and the mixture was allowed to react for 4 hours. After 4 hours of reaction, the mixture was analyzed by gas chromatography to determine consumption of the Jeffamine® EDR-148 raw material. Once no Jeffamine® EDR-148 raw material was observable by gas chromatography, the N,N-dimethylacetamide was removed by distillation under reduced pressure (ca. 50 mmHg, 125-130° C. mantle temperature).

### Step 3: Preparation of Type B (Meth)Acrylate Functionalized Amide-Containing Oligomer

The amic diacid obtained in Step 2 was re-suspended in 650 g toluene. The entire portion of oligo(ester-amide) diol prepared in Step 1 was added to the toluene suspension of amic diacid and 20 g of phenylboronic acid was added. The addition funnel was replaced by a Dean-Stark-type sidearm and the mixture was heated at reflux under nitrogen until the hydroxyl number of the neutralized reaction mixture was in the range of 76.5-82.5 mg KOH/g. Once this value was reached, the reaction mixture was cooled to room temperature, transferred to a 2 L washing flask equipped with a mechanical stirrer, thermocouple, and heating mantle, and neutralized with 98 g 20% aqueous sodium hydroxide; the mixture was held at 50° C. to allow the aqueous and organic layers to separate. The aqueous layer was discarded. Finally, the so-obtained toluene solution of oligo(ester-amide) was transferred to a 1 L round bottom flask equipped with a mechanical stirrer, air sparge line, and a thermocouple. To this solution was added 2.0 g MEHQ, 53 g of methacryloyl chloride, and 52 g of triethylamine. This mixture was stirred at room temperature for 60 minutes and then was heated to reflux for 2-2.5 hours with air sparge. The mixture was then cooled to room temperature, filtered through 50 micron filters to remove precipitates, and washed with 25% aqueous sodium hydroxide. The product was re-inhibited using 0.70 g of BHT and the toluene was removed by distillation with air sparge under reduced pressure, affording the Type B (meth)acrylate functionalized amide-containing oligomer as a crystalline solid.

In particular, the product thus obtained contained a Type B (meth)acrylate functionalized amide-containing oligomer corresponding to structure (IIe):

A¹—[O—(CHR¹)ₐ—C(═O)]_{w}—N(R²)—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—c(═O)]_{y}—N(R²)—R³—N(R²)—[C(═O)—(CHR¹)ₐ—O]_{z}—A² (IIe)

wherein each a=5; each R¹═H;
each R²═H; each R³=-Cyclohexyl-CH2-Cyclohexyl-, wherein Cyclohexyl=an unsubstituted cyclohexyl moiety; each R⁴=—CH₂CH₂—; each R⁵═H;
R⁶═—CH₂CH₂OCH₂CH₂OCH₂CH₂—
A¹ and A²=—C(═O)—CR^{c}═CH₂ (XIII)
R^{c}=methyl.

In this Example, the approximate values of w, x, y, and z were: w=x=z˜1.5, y=1 and c=1

### Prophetic Example 2: Synthesis of a Type A (Meth)Acrylate Functionalized Amide-Containing Oligomer

A sample of α,ω-diamino polyamide 12-block-poly(tetramethylene oxide)-block-polyamide 12 is dissolved in tetrahydrofuran at room temperature and two equivalents of methyl methanesulfonate are added slowly, not allowing the temperature to rise above 35° C. Once this is completed, the resulting α,ω-(N-methylamino) polyamide 12-block-poly(tetramethylene oxide)-block-polyamide 12 solution is treated with two equivalents of hexane-1,6-diyl diacrylate. Once the reaction is complete as determined by consumption of hexane-1,6-diyl diacrylate, toluene is added to the solution and the tetrahydrofuran is removed under vacuum with gentle heating. The resulting toluene solution of the desired α,ω-(N-methyl-N-(1-acryloxy-6-propionate-hexanediyl)-polyamide 12-block-poly(tetramethylene oxide)-block-polyamide 12 is neutralized by washing with 10% w/w (based on the weight of the toluene solution) of 25% aqueous NaOH and the aqueous layer is discarded. BHT is added to give a total inhibitor content of 1000 ppm based on oligomer weight, and the toluene is removed at 50 mmHg/80° C. (nominal target temperature/pressure) with air sparge to provide a Type A (meth)acrylate functionalized amide-containing oligomer.

### Example 3: Synthesis of a Type B (Meth)Acrylate Functionalized Amide-Containing Oligomer

A 1000 mL resin kettle equipped with a mechanical stirrer, dry air sparge line, thermocouple, and heating mantle was charged with 188.18 g m-xylylene diisocyanate, 0.05 g of Reaxis® C716 (urethane catalyst from Reaxis), and 750 mg BHT and heated to 60° C. 276.40 g of the oligo(ester-amide) diol described in Step 1 of Example 1 was melted at 100° C. and charged into the kettle with vigorous stirring at a rate necessary to maintain the reaction exotherm to raise the temperature to 90-100° C. At the end of the feed, the reactor was cooled to 85° C. and 65.10 g of 2-hydroxyethylmethacrylate was added over 60 minutes and allowed to react until residual NCO groups were <1000 ppm as determined by FT-IR. The resulting oligomer is a Type B (meth)acrylate functionalized amide-containing oligomer according to structure (IIa):

A¹—[O—(CHR¹)ₐ—C(═O)]_{w}—N(R²)—R³—N(R²)—[C(═O)—(CHR¹)ₐ—O]ₓ—A² (IIa)

wherein each a=5; each R¹═H; each R²=H; each R³=-Cyclohexyl-CH₂-Cyclohexyl-, wherein Cyclohexyl=an unsubstituted cyclohexyl moiety;
w=1 and x=2
A¹ and A²=—C(═O)—NH—R^{b}—NH—C(═O)—O—R^{d}—Y—C(═O)—CR^{c}═CH₂ (XVII)
Rb =-CH2-Phenyl-CH2-, Rd =-CH2-CH2-, Y═O, and R^{c}=methyl.

### Prophetic Example 4: Synthesis of a Type B (Meth)Acrylate Functionalized Amide-Containing Oligomer

A 1000 mL round bottom flask equipped with a mechanical stirrer, dry gas sparge line, thermocouple, heating mantle, reflux condenser, and addition funnel is charged with 174.20 g of the amic diacid prepared in Step 2 of Example 1 and 250 g of N,N-dimethylacrylamide. The reactor is sparged with a stream of dry air and the stirrer is set to between 150 and 250 RPM. The reaction mixture is heated to 45° C. and 130.62 g toluene diisocyanate (TDI, mixture of isomers) is added through the addition funnel over the course of 45 minutes. Once the reaction is complete (as determined by FT-IR monitoring of the isocyanate band at 2250 cm⁻¹), 300 mg of 4-methoxyphenol are added to the mixture. Once the mixture is re-homogenized 65.10 g of 2-hydroxyethylmethacrylate (HEMA) is added over 60 minutes and allowed to react until residual NCO groups are <1000 ppm as determined by FT-IR. The mixture is then discharged and used as a liquid resin. The solid α,ω-(methacryloyloxyethyl)oligo(amide) may be recovered by removal of the N,N-dimethacrylamide under reduced pressure with an air sparge (ca. 125 mmHg @ 65° C.). The resulting product is an oligomer according to structure (IIc):

A¹—C(═O)—R⁴—C(═O)—[N(R⁵)—R⁶—N(R⁵)—C(═O)—R⁴—C(═O)]_{c}—A² (IIc);

wherein R⁴=—CH₂CH₂—; each R⁵=H; R⁶=—CH₂CH₂OCH₂CH₂OCH₂CH₂—; c=1
A¹ and A²=—NH—R^{b}—NH—[C(═O)—O—R^{d}—O]ᵣ—C(═O)—CR^{c}═CH₂ (XXI);
R^{b}=-Toluene-, R^{d}=—CH₂—CH₂—, R^{c}=methyl and r is 1.

### Prophetic Example 5: Synthesis of a Type B (Meth)Acrylamide Functionalized Amide-Containing Oligomer

The procedure of example 4 is followed, but 65.10 g of 2-hydroxyethylmethacrylate is replaced by 43.04 g methacrylic acid to afford an α,ω-(methacrylamido)oligo(amide) and 1000 ppm of hydroquinone is added to improve stability. The resulting product is an oligomer according to structure (IIc):

A¹—C(═O)—R⁴—C(═O)—[N(R⁵)—R⁶—N(R⁵)—C(═O)—R⁴—C(═O)]_{c}—A² (IIc);

wherein R⁴=—CH₂CH₂—; each R⁵=H; R⁶=—CH₂CH₂OCH₂CH₂OCH₂CH₂—; c=1
A¹ and A²=—NH—R^{b}—NH—[C(═O)—O—R^{d}—O]ᵣ—C(═O)—CR^{c}═CH₂ (XXI);
R^{b}=-Toluene-, R^{c}=methyl and r is 0.

### Example 6: Synthesis of a Type B (Meth)Acrylamide Functionalized Amide-Containing Oligomer

A 1000 mL round bottom flask equipped with a mechanical stirrer, dry gas sparge line, thermocouple, heating mantle, reflux condenser, and addition funnel was charged with 0.22 g BHT, 0.08 g bismuth octoate, 410.20 g poly(tetramethylene oxide) polyol, Mₙ=2000, (BASF) and 250.07 g poly(tetramethylene oxide) polyol, Mₙ=1000 (BASF), under N₂ sparge and heated to 120° C. with stirring. Once the target temperature was reached, 90.11 g succinic anhydride were added over 45 minutes and the mixture was held at 120-130° C. for 3 hours. A slight exotherm, ca. 5° C., was observed. The resulting mixture of acid-terminated poly(tetramethylene oxide) prepolymers are cooled to 80° C. and the N₂ sparge was replaced with air sparge. After allowing 10 minutes for aeration, 38.65 g 2-hydroxyethyl methacrylate, 100 g of hexanediol dimethacrylate (SR238, Sartomer) and 1.07 g succinic acid were added and the mixture was homogenized for a further 15 minutes, and the mixture was cooled to 60° C. Once the mixture was homogenized, 48.82 g of toluene diisocyanate (Mondur TD80 grade B, Covestro) were added over 45 minutes. The reaction mixture was held at 55-65° C. for 6 hours and the free isocyanate content was monitored by FT-IR spectroscopy or by titration. Once the level of free NCO groups dropped below 1000 ppm, the product was discharged as a viscous, hazy, colorless to light yellow liquid. The resulting product comprises an oligomer according to structure (IIg):

A¹—C(═O)—NH—R¹³—NH—[C(═O)—R⁴—C(═O)—NH—R¹³—NH]ₑ—C(═O)—A² (IIg)

wherein R⁴ is a moiety comprising ether and ester linkages derived from the reaction of succinic acid and poly(tetramethylene oxide) polyol;
R¹³=-Toluene-; e=1;
A¹ and A²=—O—R^{d}—Y—C(═O)—CR^{c}═CH₂ (XIX);
R^{d}=—CH₂—CH₂—, Y═O, and R^{c}=methyl.

### Example 7: Synthesis of a Type B (meth)acrylamide Functionalized Amide-Containing Oligomer

The procedure of example 6 was followed but 25.51 g methacrylic acid were added instead of the 38.65 g 2-hydroxyethyl methacrylate and 0.15 g hydroquinone was added to improve stability.

The resulting product comprises an oligomer according to structure (IId):

A¹—N(R⁵)—R⁶—N(R⁵)—[C(═O)—R⁴—C(═O)—N(R⁵)—R⁶—N(R⁵)]_{d}—A² (IId);

wherein R⁴ is a moiety comprising ether and ester linkages derived from the reaction of succinic acid and poly(tetramethylene oxide) polyol;

R⁵=H, R⁶=-Toluene-; d=1;
A¹ and A²=—C(═O)—CR^{c}═CH₂ (XIII)
R^{c}=methyl.

1. A (meth)acryloyl-functionalized amide-containing oligomer, wherein the (meth)acryloyl-functionalized amide-containing oligomer either:
i.) comprises at least one polyamide block and at least one non-polyamide block and is substituted with at least one (meth)acryloyl functional group; or
ii.) has structure (IIa) or structure (IIb) or structure (IIc) or structure (IId) or structure (IIe) or structure (IIf) or structure (IIg):
A¹—[O—(CHR¹)ₐ—C(═O)]_{w}—N(R²—R³—N(R²)—[C(═O)—(CHR¹)ₐ—O]ₓ—A² (IIa);
A¹—[NH—(CHR¹)_{b}—C(═O)]_{w}—NH—R³—NH—[C(═O)—(CHR¹)_{b}—NH]ₓ—A² (IIb);
A¹—C(═O)—R⁴—C(═O)—[N(R⁵)—R⁶—N(R⁴)—C(═O)—R⁴—C(═O)]_{c}—A² (IIc);
A¹—N(R⁵)—R⁶—N(R⁵)—[C(═O)—R⁴—C(═O)—N(R⁵)—R⁶—N(R⁵)]_{d}—A² (IId);
A¹—[O—(CHR¹)ₐ—C(═O)]_{w}—N(R²)—R³—N(R²)—[C(═O)—(CHR¹)ₐ—O]ₓ—C(═O)—R⁴—C(═O)—[N(R⁵)—R⁶—N(R⁵)—C(═O)—R⁴—C(═O)]_{c}—[O—(CHR¹)ₐ—C(═O)]_{y}—N(R²)—R³—N(R²)—[C(═O)—(CHR¹)ₐ—O]_{z}—A² (IIe);
A¹—[NH—(CHR¹)_{b}—C(═O)]_{w}—NH—R³—NH—[C(═O)—(CHR¹)_{b}—NH]ₓ—C(═O)—R⁴—C(═O)—[N(R⁵)—R⁶—N(R⁵)—C(═O)—R⁴—C(═O)]ₓ—[NH—(CHR¹)_{b}—C(═O)]_{y}—NH—R³—NH—[C(═O)—(CHR¹)_{b}—NH]_{z}—A² (IIf);
A¹—C(═O)—NH—R¹³—[NH—C(═O)—R⁴—C(═O)—NH—R¹³]ₑ—NH—C(═O)—A² (IIg)
wherein A¹ and A² are the same or different and are (meth)acryloyl-containing moieties,
a is an integer of 2 to 5,
b is an integer of 2 to 12;
c, d, e w, x, y and z are the same or different and are each an integer of 1 or more,
R¹, R² and R⁵ are the same or different and are each H or an alkyl group, and
R³, R⁴, R⁶ and R¹³ are the same or different and are each a divalent organic moiety.

2. The (meth)acryloyl-functionalized amide-containing oligomer of claim 1, wherein the (meth)acryloyl-functionalized amide-containing oligomer is a (meth)acrylate-functionalized amide-containing oligomer.

3. The (meth)acryloyl-functionalized amide-containing oligomer of claim 1, wherein the (meth)acryloyl-functionalized amide-containing oligomer is a (meth)acrylamide-functionalized amide-containing oligomer.

4. The (meth)acryloyl-functionalized amide-containing oligomer of claim 1, wherein the (meth)acryloyl-functionalized amide-containing oligomer comprises at least one polyamide block and at least one non-polyamide block and the at least one polyamide block comprises at least one polyamide block selected from the group consisting of polyamide 6,6 blocks; polyamide 6,10 blocks; polyamide 10,10 blocks; polyamide 6,12 blocks; polyamide 4,6 blocks; polyamide 6 blocks; polyamide 11 blocks; and polyamide 12 blocks, wherein each polyamide block has a number average molecular weight of 400 g/mol to 75,000 g/mol, and each non-polyamide block preferably has a number average molecular weight of 100 g/mol to 75,000 g/mol.

5. The (meth)acryloyl-functionalized amide-containing oligomer of claim 1, wherein the (meth)acryloyl-functionalized amide-containing oligomer comprises at least one polyamide block and at least one non-polyamide block and the at least one non-polyamide block is selected from the group consisting of polyether blocks, polyester blocks, polyether-ester blocks, polycarbonate blocks, polydiene blocks and polyorganosiloxane blocks, preferably polyether blocks and polyorganosiloxane blocks.

6. The (meth)acryloyl-functionalized amide-containing oligomer of claim 1, wherein the (meth)acryloyl-functionalized amide-containing oligomer comprises at least one polyamide block and at least one non-polyamide block and the at least one non-polyamide block is selected from the group consisting of polyethylene glycol blocks, polypropylene glycol blocks, polytrimethylene glycol blocks, polytetramethylene glycol blocks, and polydimethylsiloxane blocks.

7. The (meth)acryloyl-functionalized amide-containing oligomer of claim 1, wherein the (meth)acryloyl-functionalized amide-containing oligomer comprises at least one polyamide block and at least one non-polyamide block and each (meth)acryloyl group is substituted at a terminal position of a block copolymer segment comprised of at least one polyamide block and at least one non-polyamide block.

8. The (meth)acryloyl-functionalized amide-containing oligomer of claim 7, wherein the block copolymer segment has either: (i) the structure —(A—B)ₘ— or —(A—B)ₙ—A— wherein each of m and n is an integer of at least 1, A is a polyamide block, and B is a non-polyamide block or (ii) the structure —A—B—A— wherein A is a polyamide block and B is a non-polyamide block.

9. The (meth)acryloyl-functionalized amide-containing oligomer of claim 1, wherein the (meth)acryloyl-functionalized amide-containing oligomer comprises at least one polyamide block and at least one non-polyamide block and the at least one polyamide block has a glass transition temperature of 30° C. or more and the at least one non-polyamide block has a glass transition temperature of 0° C. or less.

10. The (meth)acryloyl-functionalized amide-containing oligomer of claim 1, wherein the (meth)acryloyl-functionalized amide-containing oligomer comprises at least one polyamide block and at least one non-polyamide block and the (meth)acryloyl-functionalized amide-containing oligomer is substituted with at least one (meth)acrylate group-containing moiety having structure (I):
—N[CH₂CH₂C(═O)OCH₂CH(OH)CH₂OC(═O)C(CH₃)═CH₂]₂ (I).

11. The (meth)acryloyl-functionalized amide-containing oligomer of claim 1, wherein the (meth)acryloyl-functionalized amide-containing oligomer comprises at least one polyamide block and at least one non-polyamide block and the (meth)acryloyl-functionalized amide-containing oligomer is:
(A) a reaction product of a) an amine- or hydroxyl-functionalized block copolymer comprising at least one polyamide block and at least one non-polyamide block and b) a (meth)acryloyl-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; (meth)acrylic alkyl esters; poly(meth)acrylate-functionalized compounds; and cyclocarbonate-functionalized (meth)acrylates;
(B) a reaction product of a) an isocyano-functionalized block copolymer comprising at least one polyamide block and at least one non-polyamide block and b) a hydroxyl-functionalized (meth)acrylate or a hydroxyl-functionalized (meth)acrylamide; or
(C) an anionically polymerized lactam end-capped with at least one epoxide comprising at least one epoxy-functional (meth)acrylic monomer.

12. A method of making a (meth)acryloyl-functionalized amide-containing oligomer in accordance with claim 1, in which the (meth)acryloyl-functionalized amide-containing oligomer comprises at least one polyamide block and at least one non-polyamide block, wherein the method comprises:
(A) reacting a) an amine- or hydroxyl-functionalized block copolymer comprising at least one polyamide block and at least one non-polyamide block and b) a (meth)acryloyl-functionalizing reagent selected from the group consisting of isocyano-functionalized (meth)acrylates; epoxy-functionalized (meth)acrylates; (meth)acryloyl halides; (meth)acrylic acid; (meth)acrylic anhydride; (meth)acrylic alkyl esters; poly(meth)acrylate-functionalized compounds; and
cyclocarbonate-functionalized (meth)acrylates;
(B) reacting a) an isocyano-functionalized block copolymer comprising at least one polyamide block and at least one non-polyamide block and b) a hydroxyl-functionalized (meth)acrylate or a hydroxyl-functionalized (meth)acrylamide; or
(C) end-capping an anionically polymerized lactam with at least one epoxide comprising at least one epoxy-functional (meth)acrylic monomer.

13. The (meth)acryloyl-functionalized amide-containing oligomer of claim 1, wherein the (meth)acryloyl-functionalized amide-containing oligomer has structure (IIa) or (IIb) or (IIc) or (IId) or (IIe) or (IIf) or (IIg) and R¹, R² and R⁵ are each H.

14. The (meth)acryloyl-functionalized amide-containing oligomer of claim 1, wherein the (meth)acryloyl-functionalized amide-containing oligomer has structure (IIa) or (IId) and w+x=2-10 or has structure (IIe) or (IIf) and w+x+y+z=4-20.

15. The (meth)acryloyl-functionalized amide-containing oligomer of claim 1, wherein the (meth)acryloyl-functionalized amide-containing oligomer has structure (IIa) or (IIb) or (IIc) or (IId) or (IIe) or (IIf) or (IIg), R³ and R⁶ are independently selected from a straight chain or branched divalent alkylene; a chloralkyl moiety; a moiety containing one or more optionally substituted aromatic groups such as —Ar—, —Ar—Ar—, —Ar—CH₂—Ar—, —Ar—O—Ar—, —Ar—SO₂—Ar— or —CH₂—Ar—CH₂—; a moiety containing one or more optionally substituted cycloaliphatic groups such as -Cy-, —CH₂-Cy-, —CH₂-Cy-CH₂—, -Cy-CH₂-Cy- or -Cy-S-Cy-; or a divalent alkylene ether moiety such as -Alk¹-O(Alk²O)ᵥAlk³-;
wherein each Ar is independently an optionally substituted aryl;
each Cy is independently an optionally substituted cycloalkyl;
Alk¹, Alk² and Alk³ are the same or different and are each a divalent straight chain or branched alkylene moiety, and
v is 0 or an integer of 1 or more.

16. The (meth)acryloyl-functionalized amide-containing oligomer of claim 1, wherein the (meth)acryloyl-functionalized amide-containing oligomer has structure (IIa) or (IIb) or (IIe) or (IIf), R³ is —CH₂—Ar—CH₂—, wherein Ar is an aromatic group or -Cyclohexyl-CH₂-Cyclohexyl-, wherein Cyclohexyl is a divalent cyclohexyl moiety, which may be substituted or unsubstituted.

17. The (meth)acryloyl-functionalized amide-containing oligomer of claim 1, wherein the (meth)acryloyl-functionalized amide-containing oligomer has structure (IIc) or (IId) or (IIe) or (IIf), R⁶ is a divalent alkylene ether moiety such as -Alk¹-O(Alk²O)ᵥAlk³-, wherein v is 0 or an integer of 1 or more, and Alk¹, Alk² and Alk³ are the same or different and are each a divalent straight chain or branched alkylene moiety.

18. The (meth)acryloyl-functionalized amide-containing oligomer of claim 1, wherein the (meth)acryloyl-functionalized amide-containing oligomer has structure (IIa) or (IIb) or (IIc) or (IId) or (IIe) or (IIf) or (IIg) and A¹ and A² are selected from the group consisting of one of the following structures (XIII)-(XXII):
—C(═O)—CR^{c}═CH₂ (XIII);
—C(═O)—NH—R^{b}—O—C(═O)—CR^{c}═CH₂ (XIV);
—CH₂—CH(OH)—R^{b}—O—C(═O)—CR^{c}═CH₂ (XV)
—CH₂—CH₂—C(═O)—O—R^{b}—O—C(═O)—CR^{c}═CH₂ (XVI);
—C(═O)—NH—R^{b}—NH—C(═O)—O—R^{d}—Y—C(═O)—CR^{c}═CH₂ (XVII);
—C(═O)—R^{b}—C(═O)—O—CH₂—CH(OH)—CH₂—[O—R^{d}—O—CH₂—CH(OH)—CH₂]_{q}—O—C(═O)—CR^{c}═CH₂ (XVIII);
—O—R^{d}—Y—C(═O)—CR^{c}═CH₂ (XIX);
—O—CH₂—CH(OH)—R^{b}—O—C(═O)—CR^{c}═CH₂ (XX);
—NH—R^{b}—NH—[C(═O)—O—R^{d}—O]ᵣ—C(═O)—CR^{c}═CH₂ (XXI);
—C(═O)—O—R^{b}—O—C(═O)—CR^{c}═CH₂ (XXII);
wherein each RC is independently H or methyl,
R^{b} and R^{d} are each independently a divalent organic moiety,
Y is O or NH,
q is 0 to 10, and
r is 0 or 1.

19. The (meth)acryloyl-functionalized amide-containing oligomer of claim 18, wherein the (meth)acryloyl-functionalized amide-containing oligomer has structure (IIa) and A¹ and A² are independently selected from the group consisting of one of structures (XIII), (XIV), (XVI), (XVII) and (XVIII).

20. The (meth)acryloyl-functionalized amide-containing oligomer of claim 18, wherein the (meth)acryloyl-functionalized amide-containing oligomer has structure (IIb) or (IId) and A¹ and A² are independently selected from the group consisting of one of structures (XIII), (XIV), (XV), (XVI), (XVII), (XVIII) and (XXII).

21. The (meth)acryloyl-functionalized amide-containing oligomer of claim 18, wherein the (meth)acryloyl-functionalized amide-containing oligomer has structure (IIc) and A¹ and A² are independently selected from the group consisting of one of structures (XIX), (XX) and (XXI).

22. The (meth)acryloyl-functionalized amide-containing oligomer of claim 18, wherein the (meth)acryloyl-functionalized amide-containing oligomer has structure (IIe) and A¹ and A² are independently selected from the group consisting of one of structures (XIII), (XIV), (XVI), (XVII) and (XVIII).

23. The (meth)acryloyl-functionalized amide-containing oligomer of claim 18, wherein the (meth)acryloyl-functionalized amide-containing oligomer has structure (IIf) and A¹ and A² are independently selected from the group consisting of one of structures (XIII), (XIV), (XV), (XVI), (XVII), (XVIII) and (XXII).

24. The (meth)acryloyl-functionalized amide-containing oligomer of claim 18, wherein the (meth)acryloyl-functionalized amide-containing oligomer has structure (IIg) and A¹ and A² correspond to structure (XIX).

25. A curable composition comprised of at least one (meth)acryloyl-functionalized amide-containing oligomer in accordance with claim 1 further comprising at least one additional component and, optionally, a photoinitiator.

26. The curable composition of claim 25, wherein the at least one additional component comprises at least one at least one (meth)acrylamide-functionalized monomer or oligomer containing at least one (meth)acrylamide functional groups per molecule.

27. The curable composition of claim 25, wherein the curable composition is selected from the group consisting of adhesives, sealants, coatings, three dimensional printing and additive manufacturing resins, inks and molding resins.

28. A method of making a cured polymeric material, wherein the method comprises curing the curable composition of claim 25 using actinic radiation.

29. A method of making a three-dimensional article by additive manufacturing, comprising using the curable composition of claim 25 to manufacture the three-dimensional article.
